(19) United States
(12) Patent Application Publication
(10) Pub. No.: US 2026/0281484 A1
(43) Pub. Date: Sep. 17, 2026

(54) DATA PROCESSING METHOD AND APPARATUS, DEVICE, AND READABLE STORAGE MEDIUM

(71) Applicant: TENCENT TECHNOLOGY (SHENZHEN) COMPANY LIMITED, Shenzhen (CN)

(72) Inventor: Haixu HAN, Shenzhen (CN)

(21) Appl. No.: 19/674,536

(22) Filed: May 12, 2026

Related U.S. Application Data
(63) Continuation of application No. PCT/CN2024/140620, filed on Dec. 19, 2024.

(30) Foreign Application Priority Data
Jan. 11, 2024 (CN) 202410039666.1

(51) Int. Cl. H04N 21/2662; H04N 19/115; H04N 19/136; H04N 19/196; H04N 19/40; H04N 21/234; H04N 21/2343; H04N 21/24; H04N 21/25

(52) U.S. Cl. CPC H04N 21/2662; H04N 19/115; H04N 19/136; H04N 19/197; H04N 19/40; H04N 21/23418; H04N 21/234363; H04N 21/2402; H04N 21/251

(57) ABSTRACT

A data processing method includes: acquiring a media object sequence to be played; determining an initial media encoding parameter of each media object based on a predicted network speed corresponding to the media object sequence; selecting a target media object whose media quality does not satisfy a preset quality condition from the media object sequence based on a media quality of each media object at the corresponding initial media encoding parameter; analyzing the initial media encoding parameter of the target media object based on the predicted network speed to obtain an analysis result; and adjusting the initial media encoding parameter of the target media object in response to the analysis result indicating that the initial media encoding parameter of the target media object satisfies a parameter adjustment condition.

### CROSS-REFERENCES TO RELATED APPLICATIONS

This application is a continuation of PCT Application No. PCT/CN2024/140620, filed on Dec. 19, 2024, which claims priority to Chinese Patent Application No. 2024100396661, filed with the China National Intellectual Property Administration on Jan. 11, 2024 and entitled “DATA PROCESSING METHOD AND APPARATUS, DEVICE, AND READABLE STORAGE MEDIUM”, the entire contents of all of which are incorporated herein by reference.

### FIELD OF THE TECHNOLOGY

The present disclosure relates to the technical field of computers, and in particular, to a data processing method and apparatus, a device, and a readable storage medium.

### BACKGROUND OF THE DISCLOSURE

With the development of broadcast technology and network video applications, media objects (a media object may refer to an object presented in a media presentation form; media presentation forms may include, but are not limited to, a video presentation form, an image presentation form, and an audio presentation form. Specifically, a media object may refer to an object presented in a video presentation form, such as a certain video; or may refer to an object presented in an image presentation form, for example, a certain image. In other words, a media object may refer to a video, an image, an audio, etc.) have become an important part of people's daily lives. People use media objects, such as videos, for entertainment or learning.

Taking the media object being a video as an example, currently, video viewing mostly needs to be performed through a wireless network (for example, Wi-Fi) or mobile data. If the wireless network is unstable or a user moves, an available bandwidth of the video fluctuates within a certain range. Network fluctuations may cause a decrease in bandwidth, leading to video playback freezes, which significantly impairs user experience.

To improve the problem of video playback freezes, relevant encoding parameters (such as bit rate and resolution) of a video are adjusted in a one-size-fits-all way (for example, the bit rate of the entire video is reduced) based on a predicted network condition to adapt to the predicted network condition. However, since different videos contain different video contents, and the clarity of different video contents at the same encoding parameter (such as bit rate) varies (for example, a video with a complex content may have low clarity at a low bit rate, while a video with a simple content may have high clarity at the same low bit rate), the above one-size-fits-all bit rate adjustment, although preventing bit rate fluctuations when playing a batch of videos, may result in some videos having an excessively low quality and some videos having an excessively high quality, thereby reducing the overall playback quality of the videos. Therefore, there is an urgent need for an encoding parameter adjustment to improve the overall playback quality of videos.

### SUMMARY

Embodiments of the present disclosure provide a data processing method and apparatus, a device, and a readable storage medium, which can implement dynamic adjustment of a media encoding parameter of a media object, thereby improving the overall playback quality of the media object.

According to an aspect, an embodiment of the present disclosure provides a data processing method, including: acquiring a media object sequence to be played, the media object sequence being composed of a plurality of media objects; determining an initial media encoding parameter corresponding to each media object based on a predicted network speed corresponding to the media object sequence; selecting a target media object whose media quality does not satisfy a preset quality condition from the media object sequence based on a media quality of each media object at the corresponding initial media encoding parameter, satisfying the preset quality condition referring to a media quality being not higher than a quality upper limit threshold or not lower than a quality lower limit threshold; analyzing the initial media encoding parameter of the target media object based on the predicted network speed to obtain an analysis result, the analysis result indicating whether the initial media encoding parameter of the target media object satisfies a parameter adjustment condition; and adjusting the initial media encoding parameter of the target media object in response to the analysis result indicating that the initial media encoding parameter of the target media object satisfies the parameter adjustment condition, a media quality of the target media object at an adjusted media encoding parameter satisfying the preset quality condition.

According to an aspect, an embodiment of the present disclosure provides a computer device, including: a processor and a memory, the memory having a computer program stored therein, the computer program, when executed by the processor, causing the processor to perform the method in the embodiment of the present disclosure.

According to an aspect, an embodiment of the present disclosure provides a non-transitory computer-readable storage medium, having a computer program stored therein, the computer program including a program instruction, when the program instruction being executed by a processor, the method in the embodiment of the present disclosure being performed.

In the embodiments of the present disclosure, after acquiring a media object sequence to be played (a sequence composed of N media objects), an initial media encoding parameter of each media object may be first determined based on a predicted network speed corresponding to the media object sequence. In this way, the initial media encoding parameter of each media object is adapted to both the predicted network speed and the media object itself. Further, the present disclosure may consider a media quality, and adjust the initial media encoding parameter of a media object that does not satisfy a preset quality condition. Specifically, the present disclosure may first select, according to a media quality of each media object at its own initial media encoding parameter, a media object that does not satisfy the preset quality condition as a target media object. The media quality of the target media object at the initial media encoding parameter is either too high (higher than a quality upper limit threshold) or too low (lower than a quality lower limit threshold). Therefore, the initial media encoding parameter thereof needs to be adjusted, so that the media quality thereof can be a quality that is neither too high nor too low. For the target media object, the initial media encoding parameter of the target media object may be analyzed based on the predicted network speed, to analyze, under a constraint of the predicted network speed, whether the initial media encoding parameter of the target media object satisfies a parameter adjustment condition. If an analysis result indicates that the initial media encoding parameter of the target media object satisfies the parameter adjustment condition, the initial media encoding parameter of the target media object is adjusted, and the media quality of the adjusted target media object satisfies the preset quality condition. Thus, it can be seen that the embodiments of the present disclosure provide a media encoding parameter adjustment solution based on a predicted network speed and a media quality. A media encoding parameter adapted to a media object itself may be determined based on the predicted network speed, and under the constraint of the predicted network speed, the media encoding parameter of a media object whose media quality does not satisfy a media viewing condition is adaptively adjusted, so that the media quality thereof satisfies the media viewing condition. Since the adjustment of the media encoding parameter is performed under the constraint of the predicted network speed, the adjusted media encoding parameter is also adapted to the predicted network speed. In summary, the embodiments of the present disclosure can allocate different media encoding parameters to different media objects under the constraint of the predicted network speed, and can dynamically optimize, under the constraint of the predicted network speed, the media encoding parameter of a media object in the media object sequence that does not satisfy the preset quality condition, so that the media object satisfies the preset quality condition, thereby improving or enhancing the overall playback quality of the media object sequence.

### BRIEF DESCRIPTION OF THE DRAWINGS

FIG. 1 is a schematic architectural diagram of a system for dynamically adjusting a media encoding parameter according to an exemplary embodiment of the present disclosure.

FIG. 2 is a schematic diagram of a scenario according to an embodiment of the present disclosure.

FIG. 3 is a schematic flowchart of a data processing method according to an exemplary embodiment of the present disclosure.

FIG. 4 is a schematic flowchart of analyzing an initial media encoding parameter according to an embodiment of the present disclosure.

FIG. 5 is a schematic flowchart of performing parameter adjustment on an additional adjustment media object according to an embodiment of the present disclosure.

FIG. 6 is a schematic diagram of a system logical architecture according to an embodiment of the present disclosure.

FIG. 7 is a schematic structural diagram of a data processing apparatus according to an embodiment of the present disclosure.

FIG. 8 is a schematic structural diagram of a computer device according to an embodiment of the present disclosure.

### DESCRIPTION OF EMBODIMENTS

Embodiments of the present disclosure relate to artificial intelligence and related technologies. For ease of understanding, the following will first briefly describe artificial intelligence and related technical terms and concepts.

### Artificial Intelligence (AI)

Artificial intelligence involves a theory, a method, a technology, and an application system that use a digital computer or a machine controlled by the digital computer to simulate, extend, and expand human intelligence, perceive an environment, obtain knowledge, and use knowledge to obtain an optimal result. Artificial intelligence is to study the principles and implementation methods of various intelligent machines, to enable the machines to have the functions of perception, reasoning, and decision-making. Artificial intelligence technology is a comprehensive discipline, and relates to a wide range of fields including both hardware-level technologies and software-level technologies. Basic artificial intelligence technologies generally include technologies such as sensors, dedicated artificial intelligence chips, cloud computing, distributed storage, big data processing technology, operating/interaction systems, and electromechanical integration. Artificial intelligence software technologies mainly include several major directions such as a computer vision technology, a speech processing technology, a natural language processing technology, and machine learning/deep learning.

With the research and progress of artificial intelligence technology, the artificial intelligence technology is being studied and applied in a plurality of fields, such as common smart homes, smart wearables, virtual assistants, smart speakers, smart marketing, unmanned driving, autonomous driving, drones, robots, intelligent health care, and intelligent customer service. It is believed that with the development of technology, artificial intelligence technology will be applied in more fields and play an increasingly important role.

Further, the embodiments of the present disclosure mainly relate to technologies such as machine learning (ML) in artificial intelligence technology. Machine learning is a multi-field interdiscipline, and relates to a plurality of disciplines such as probability theory, statistics, approximation theory, convex analysis, and algorithm complexity theory. Machine learning specializes in studying how a computer simulates or implements a human learning behavior to obtain new knowledge or skills, and reorganize an existing knowledge structure, so as to keep improving the computer's performance. Machine learning is the core of artificial intelligence, is a basic way to make the computer intelligent, and is applied to various fields of artificial intelligence. Machine learning and deep learning generally include technologies such as artificial neural networks, belief networks, reinforcement learning, transfer learning, inductive learning, and learning from demonstrations.

In the embodiments of the present disclosure, machine learning technology may be specifically applied to model training, for example, may be specifically applied to a prediction model for an encoding parameter of a media object. By adopting machine learning to train and learn the prediction model, the encoding parameter predicted by the prediction model can become increasingly accurate. Here, the media object may refer to a video, and the encoding parameter of the media object may refer to an encoding parameter of the video (such as bit rate, resolution, and frame rate). Content predicted by the prediction model may be determined based on the encoding parameter of the media object. For example, when the encoding parameter is a bit rate, the content predicted by the prediction model may be a bit rate, and the prediction model may refer to a model configured for bit rate prediction (which may be referred to as a bit rate prediction model). For ease of understanding, the following description will be given by taking the media object being a video and the encoding parameter of the media object (which may be referred to as a media encoding parameter) being a bit rate as an example.

In practical application, for a video to be played of a user, prediction may be first performed based on a network condition (such as network bandwidth or network speed) when the video is played, and then a bit rate of the video is determined based on the predicted network condition. Then, the video viewed by the user is a video obtained by transcoding at the predicted bit rate. For example, taking a short video recommendation scenario as an example, when a user uses a short video recommendation application, the short video recommendation application may continuously recommend different videos to the user. The user may perform an operation of pulling a video in the short video recommendation application to request to update and display a next video. The operation of pulling a video here may refer to an operation of a user sliding a video display interface of a terminal device (for example, the user sliding in a certain direction, such as sliding upward, sliding downward, sliding leftward, and sliding rightward), or may refer to an operation of the user pulling a drop-down box in the video display interface, etc., which is not limited in the present disclosure. A video being played and watched by a user may be referred to as a current video. In a short video recommendation application, one or more videos similar to the video content of the current video are usually preloaded (in practical application, the number of preloaded videos is not too large, for example, usually not more than 5, generally about 4). Then, after the user performs the operation of pulling a video, the one or more preloaded videos may be sequentially recommended to the user in order, and the user may sequentially play and watch the one or more preloaded videos by continuously performing the operation of pulling a video. When the user is playing and watching the current video, the preloaded videos that have not been played yet are videos to be played. For these videos to be played, in some cases, a network condition (such as network speed) when these videos are played may be predicted first, and then a bit rate of these videos is determined based on the predicted network condition. In this way, since the bit rate is obtained through prediction based on the predicted network condition, the predicted bit rate can be well adapted to the predicted network condition, and thus no video playback freeze occurs when the user plays and watches these videos. A background server of the short video recommendation application may transcode the videos according to the predicted bit rate, and each video viewed by the user is a video transcoded at the predicted bit rate.

Since different videos contain different video contents, for example, a certain video contains a large amount of video contents and has relatively complex scenarios, while another video contains a small amount of video contents and has relatively simple scenarios. Then, at the same bit rate, video qualities (such as definition and aesthetics) of different videos after transcoding are also different. The so-called video quality refers to the quality presented by a video after being transcoded at a bit rate, which is usually determined by indicators such as definition and aesthetics of the video. For each of the above preloaded videos, at the same predicted bit rate, the video qualities after transcoding also vary greatly. In the process of playing these videos, the quality of a certain video viewed by the user may be relatively low, but when the next video is played, its video quality may be too high, resulting in a quality jump. The overall playback quality of these videos is not high, which tends to affect user experience.

In order to improve the overall playback quality of videos, the present disclosure provides a solution for dynamically adjusting a media encoding parameter (such as bit rate) of a media object (such as a video), which can select, under a constraint of a predicted network condition (such as a predicted network speed), a media object whose media quality (such as video quality) does not satisfy a preset quality condition, and adaptively and dynamically adjust media encoding parameters of different media objects, so that the media qualities thereof can satisfy the preset quality condition. Thus, the situation of media quality jump during playback of a batch of media objects to be played can be reduced, thereby improving the overall playback quality of the media objects. The solution provided herein for dynamically adjusting a media encoding parameter of a media object may at least include three consecutive operations: 1) Acquiring a predicted network speed of a media object sequence to be played (such as the one or more preloaded videos mentioned above), and determining an initial media encoding parameter (such as an initial bit rate) of each media object in the media object sequence based on the predicted network speed. In the present disclosure, the initial media encoding parameter of each media object may be determined based on media content contained in the media object, i.e., the initial media encoding parameter of each media object may be different, but the initial media encoding parameter of each media object is adapted to the predicted network speed (being adapted to the predicted network speed here may mean being less than the predicted network speed, so that the predicted network speed can drive the initial media encoding parameter, i.e., when the media encoding parameter of the media object is the initial media encoding parameter, the predicted network speed can smoothly play the media object). That is to say, the present disclosure uses the predicted network speed as a constraint value, and determines a corresponding initial media encoding parameter for a media object based on the media content of each media object itself. Under the constraint of the predicted network speed, the initial media encoding parameter of each media object cannot be greater than the predicted network speed. 2) Acquiring a media quality of each media object under its own corresponding initial media encoding parameter, and acquiring a media object whose media quality does not satisfy a preset quality condition based on the media quality of each media object under its own corresponding initial media encoding parameter, and using it as a target media object. 3) Analyzing whether the initial media encoding parameter of the target media object satisfies a parameter adjustment condition under the constraint of the predicted network speed, and when it is determined that the parameter adjustment condition is satisfied, adjusting the initial media encoding parameter of the target media object, so that the media quality thereof satisfies the preset quality condition.

Specifically, a specific process of the solution for adjusting a media encoding parameter of a media object provided by the embodiments of the present disclosure may generally include: a media object sequence to be played (including N media objects, N being a positive integer) is acquired. After the media object sequence is acquired, based on a predicted network speed corresponding to the media object sequence, an initial media encoding parameter adapted to the predicted network speed is determined for each media object, where the predicted network speed corresponding to the media object sequence here may be determined based on a network speed within a historical time period (a time period earlier than a playback time of the media object sequence, for example, 5 s before a playback time point of a current media object and 3 s before a playback time point of a current media object). After the predicted network speed corresponding to the media object is determined, a pre-trained encoding parameter prediction model may be invoked, and then the encoding parameter prediction model is configured to analyze a media content of each media object. Under a condition of not exceeding the predicted network speed, the encoding parameter prediction model may analyze, for each media object, a maximum media encoding parameter capable of being adapted to the media content thereof, and the maximum media encoding parameter may serve as the initial media encoding parameter of the media object. Further, since media qualities obtained by transcoding using different media encoding parameters are different, and media qualities of different media objects after transcoding at the same media encoding parameter are also different, media qualities of each media object at a corresponding initial media encoding parameter may be first acquired here, thereby determining a media quality that does not satisfy a preset quality condition. In the present disclosure, the preset quality condition may refer to a condition that a media quality is not too high (for example, greater than a certain quality upper limit threshold) or not too low (for example, less than a certain quality lower limit threshold). Then, through comparison, a media quality that does not satisfy the preset quality condition (i.e., a media quality that is too high or too low) can be determined. For a media object that does not satisfy the preset quality condition, which may be referred to as a target media object in the present disclosure, analysis may be performed on the target media object under a constraint of the predicted network speed, to analyze whether an initial media encoding parameter thereof has adjustability. If it is determined that the initial media encoding parameter of the target media object has adjustability, the initial media encoding parameter of the target media object may be adjusted, so that the media quality thereof can satisfy the preset quality condition.

For example, a media object sequence is 4 preloaded videos (including video 1, video 2, video 3, and video 4), assuming a predicted network speed is 600. Based on the predicted network speed, an initial bit rate (i.e., an initial media encoding parameter) of video 1 is determined to be 480, an initial bit rate of video 2 is 500, an initial bit rate of video 3 is 580, and an initial bit rate of video 4 is 590. Using a percentage system, video qualities of each video at the corresponding initial bit rate are determined as follows: a video quality of video 1 is 50 (50 points on the percentage system), a video quality of video 2 is 70 (70 points on the percentage system), a video quality of video 3 is 95 (95 points on the percentage system), and a video quality of video 4 is 98 (98 points on the percentage system). Assuming a quality upper limit threshold is 96 and a quality lower limit threshold is 70, then the video qualities of video 1 and video 4 do not satisfy a preset quality condition, and thus the initial bit rates of video 1 and video 4 need to be adjusted (for example, the initial bit rate of video 1 is adjusted up and the initial bit rate of video 4 is adjusted down). However, in the present disclosure, for a video that does not satisfy the preset quality condition, the initial bit rate is not directly adjusted. Instead, analysis is first performed based on the predicted network speed to determine whether the initial bit rate of the video has adjustability. Under the constraint of the predicted network speed, if it is still determined that the initial bit rate has adjustability, then the initial bit rates of video 1 and video 4 are adjusted.

Thus, it can be seen that, in the process of playing media objects in the embodiments of the present disclosure, for a preloaded media object sequence, an initial media encoding parameter adapted to the predicted network speed may be allocated to each media object based on the predicted network speed. Then, based on the media quality of each media object at the corresponding initial media encoding parameter, the initial media encoding parameter of a media object that does not satisfy the preset quality condition is dynamically and adaptively adjusted, so that the media object satisfies the preset quality condition. As a result, each media object in the media object sequence conforms to the preset quality condition, i.e., conforms to a quality viewing requirement. The situation of quality jump during playback of the media object sequence is greatly reduced, the overall playback quality is improved, and the user experience can be enhanced.

The adaptive adjustment solution for the media encoding parameter provided in the embodiments of the present disclosure may be applied to application scenarios where a media object needs to be played, which may include but are not limited to: a short video recommendation scenario, a video playback scenario (a scenario that may be configured for watching a TV series, a movie, and a variety show), and a game scenario.

The short video recommendation scenario may refer to a scenario where videos are continuously recommended to a user. The user may request to update and display a next video by performing an operation of pulling a video (such as an operation of sliding a video display interface of a terminal device). Then, in the short video recommendation scenario, the user may continuously refresh and browse different videos by continuously performing the operation of pulling a video.

The video playback scenario may refer to a scenario where a user watches a video such as a TV series, a movie, or a variety show on a certain video playback platform.

In summary, the solution provided in the embodiments of the present disclosure for dynamically adjusting the media encoding parameter of the media object can combine the media quality of the media object to perform dynamic planning and adjustment on the media encoding parameter of the media object, can balance a relationship between the media encoding parameter and the media quality of the media object, and can effectively improve service coverage (such as expanding applicable scenarios) to a certain extent.

The several application scenarios given above are merely examples, and do not limit the application scenarios to which the solution for dynamically adjusting the media encoding parameter of the media object provided in the embodiments of the present disclosure is applicable.

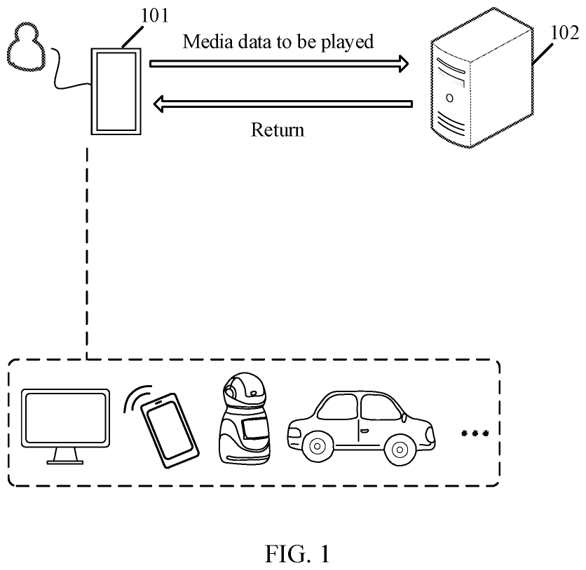

Further, the solution for dynamically adjusting the media encoding parameter provided in the embodiments of the present disclosure may be executed by a computer device, which may include a terminal or a server, or may also include a terminal and a server. For ease of understanding the solution for dynamically adjusting the media encoding parameter provided in the embodiments of the present disclosure, application scenarios involved in the embodiments of the present disclosure are introduced below with reference to a system for dynamically adjusting a media encoding parameter shown in FIG. 1. FIG. 1 is a schematic architectural diagram of a system for dynamically adjusting a media encoding parameter according to an exemplary embodiment of the present disclosure. As shown in FIG. 1, the system includes a terminal 101 and a server 102.

1) The terminal 101 may include a terminal device used by a user. Certainly, depending on the application scenarios and fields to which the solution is applied, terminals providing the solution according to the embodiments of the present disclosure may differ. Terminal devices may include, but are not limited to, smartphones (such as a smartphone deployed with an Android system, or a smartphone deployed with an internetworking operating system (IOS)), tablet computers, portable personal computers, mobile internet devices (MID), onboard devices, head-mounted devices, smart homes, and intelligent voice interaction devices. The embodiments of the present disclosure do not limit the type of the terminal device, as explained here.

For example, in a short video recommendation scenario, the terminal device may be a smartphone. That is to say, in this implementation, the solution provided in the embodiments of the present disclosure may be deployed on the smartphone. When a user uses a short video recommendation application on the smartphone, the smartphone acquires a time point when the user is currently playing a video, and then acquires a historical time period before the time point. Based on this historical time period, predicted network speeds of a plurality of preloaded videos to be played can be predicted. Then, the smartphone determines, according to the predicted network speeds, an initial bit rate of each video to be played, and dynamically adjusts, in combination with a video quality of each video at the initial bit rate, an initial bit rate of a video that does not satisfy a preset quality condition. For another example, in an intelligent onboard scenario, an application program deployed with the solution provided in the embodiments of the present disclosure is an onboard application program. Types of the onboard application program may include, but are not limited to, music, video, or game applications.

The application program may be a computer program that completes one or more particular jobs. The application program is classified according to different dimensions (such as a running mode and a function of the application program), and types of the same application program in different dimensions may be obtained. For example, as classified according to running modes of the application programs, the application programs may include, but are not limited to, a client installed in a terminal, a mini program (as a subprogram of the client) that can be used without being downloaded and installed, and a world wide web (web) application program opened through a browser. For another example, classified according to function types of application programs, application programs may include, but are not limited to, instant messaging (IM) application programs, content interaction application programs, audio application programs, or video application programs. The instant messaging application program refers to an application program that instantly exchanges messages and performs social interaction based on the Internet. The instant messaging application program may include, but is not limited to, an application program that includes a communication function, a map application program that includes an interaction function, and a game application program. The content interaction application program refers to an application program that can implement content interaction. For example, the application program may be an application program such as a sharing platform, personal space, and news. The audio application program refers to an application program that implements an audio function based on the Internet. Audio application programs may include, but are not limited to, music application programs having music playing and editing capabilities, radio application programs having radio playing capabilities, or live streaming application programs having live streaming capabilities. The video application program refers to an application program capable of playing a picture. Video application programs may include, but are not limited to, application programs having short videos (video length is often short, such as several seconds or minutes) (e.g., short video recommendation application programs) and application programs having long videos (e.g., videos with a relatively long playing time such as movies or TV series).

Certainly, the solution provided in the embodiments of the present disclosure may be directly deployed on a device (such as a smartphone) or outside an application program as described above, or may be deployed in a device or an application program in a form of a plug-in. The embodiments of the present disclosure do not limit a carrier for a deploying plan.

2) The server 102 may be a server corresponding to the terminal, and is configured to perform data interaction with the terminal to provide calculation and application service support for the terminal. Specifically, the server is a background server corresponding to an application program deployed in the terminal, and is configured to interact with the terminal to provide a computing and application server for the application program. The server 102 may be an independent physical server, or may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform.

The terminal 101 may be directly or indirectly connected to the server 102 in a wired or wireless communication, which is not limited in the present disclosure here. In addition, the embodiments of the present disclosure do not limit the number of terminals and servers. In FIG. 1, the number of the terminal 101 and the server 102 being one each is merely an example. In practical application, a plurality of distributed servers may be included, as specifically explained here.

A general process of the solution for dynamically adjusting the media encoding parameter in the application scenario will be introduced below with reference to the system shown in FIG. 1. In one embodiment, when a user plays and watches a certain video in a terminal (specifically, in an application program deployed in the terminal, such as a video-type application program) (the video being currently played and watched by the user (such as a certain short video 1) may be referred to as a current video), a server corresponding to the terminal may compose, according to a specified playing order (the specified playing order may be specifically set based on actual service requirements, for example, may be a random playing order, or may be a playing order sorted according to numbers of the videos), a plurality of videos (such as 4 videos) to be sequentially recommended to the user in order into a media object sequence to be played in the present disclosure. The above current video may be a current media object. After determining the media object sequence to be played, the server may determine, based on a historical time period of the current media object (a time period earlier than a playing time of the current media object, such as 5 s before a playing time point of the current media object), a network speed for playing the media object sequence, and the network speed may serve as a predicted network speed of the media object sequence. Then, based on the predicted network speed, the server may determine, for each media object to be played, a media encoding parameter adapted to media content of the media object itself and not greater than the predicted network speed, so as to transcode each media object based on the media encoding parameter. In the embodiments of the present disclosure, a predicted media encoding parameter of each media object may be used as an initial media encoding parameter. Further, the server may acquire a media quality of each media object obtained after transcoding at its own corresponding initial media encoding parameter (media contents of two media objects are different, so media qualities thereof may also be different even at the same media encoding parameter), and acquire a preset quality condition (for example, a condition that a media quality cannot be greater than a quality upper limit threshold or lower than a quality lower limit threshold). The server may, based on the preset quality condition, acquire a media object whose media quality does not satisfy the preset quality condition, and determine the media object as a target media object (referred to as a target media object). For each target media object, the server may perform parameter analysis on its initial media encoding parameter under a constraint of a predicted network speed, to analyze and determine whether the initial media encoding parameter of a certain media object satisfies a parameter adjustment condition. If it is determined that the initial media encoding parameter of a certain target media object satisfies the parameter adjustment condition, the server may adjust the initial media encoding parameter of the target media object, so that the media quality thereof can satisfy the preset quality condition. Then, the server may transcode each media object according to the adjusted media encoding parameter. The terminal may preload each media object sequentially according to a playing order of the transcoded media objects (i.e., pre-download the media objects to a local database of the terminal), so that each downloaded media object can be quickly recommended to a user subsequently for playing and watching.

Since the initial media encoding parameter of the target media object is adjusted under the constraint of the predicted network speed, the adjusted media encoding parameter can also be adapted to the predicted network speed. During preloading of the entire media object sequence by the terminal, preloading can be quickly completed at the predicted network speed. Then, during playing of the media object sequence, the downloaded media objects can be quickly acquired for playing. The preset quality condition is satisfied, and a situation of playback freeze due to incomplete downloading does not occur, i.e., each adjusted media object to be played cannot only be adapted to the predicted network speed to reduce playback freeze in a playing process, but also improve the overall playback quality of the media objects.

Based on the above-described solution and system architecture, the following points further need to be explained:

1) The system shown in FIG. 1 mentioned above in the embodiments of the present disclosure is intended to describe the technical solutions of the embodiments of the present disclosure more clearly, and does not constitute a limitation on the technical solutions provided in the embodiments of the present disclosure. A person of ordinary skills in the art may understand that, with the evolution of system architectures and the emergence of new service scenarios, the technical solutions provided in the embodiments of the present disclosure are equally applicable to similar technical problems. For example, the above description introduces an application scenario of the solution by taking an example where a “computer device”, as an execution entity of the embodiments of the present disclosure, includes a terminal and a server, i.e., the solution provided in the embodiments of the present disclosure is jointly executed by the terminal and the server. In practical application, the computer device may also be a terminal or a server. That is to say, it is supported that the solution provided by the embodiments of the present disclosure is executed by a terminal or a server alone.

2) The embodiments of the present disclosure support implementing the above-described solution for dynamically adjusting the media encoding parameter by adopting a model having a media encoding parameter prediction capability (such as a bit rate prediction capability) (such as a model including a structure of a recurrent neural network (RNN), a convolutional neural network (CNN), or a residual network (ResNet)). Specifically, in the present disclosure, a plurality of configured media encoding parameters corresponding to a media object (i.e., preconfigured media encoding parameters of different levels, for example, taking the media encoding parameter being a bit rate as an example, the configured media encoding parameters may be 360, 480, 720, 1080, 1280, etc.) may be deployed in the model as model parameters, and the model is trained by adopting machine learning (such as reinforcement learning), so that a result output by the model (i.e., a predicted media encoding parameter) can become increasingly accurate. The trained model may be deployed in a computer device. In this way, when the computer device needs to perform media encoding parameter prediction on a certain media object (such as predicting a bit rate, resolution and the like adapted to media content of a certain media object itself), the model may be directly invoked. The model predicts, under a constraint of a predicted network speed, a media encoding parameter adapted to media content of the certain media object itself and adapted to the predicted network speed for the media object, and the media encoding parameter may serve as an initial media encoding parameter of the media object. If the computer device for executing the solution provided in the embodiments of the present disclosure is a terminal, the model may be deployed in the terminal. If the computer device for executing the solution provided in the embodiments of the present disclosure is a server, the model is deployed in the server. In this case, a terminal used by a user transmits a media object to be predicted and the predicted network speed as a constraint condition to the server for prediction processing of the media encoding parameter.

3) Collection and processing of relevant data in the embodiments of the present disclosure need to strictly comply with the requirements of relevant laws and regulations. Acquisition of personal information needs to be subject to the knowledge or consent of a personal subject (or the legal basis for acquiring the information), and subsequent use and processing of data is carried out within the scope of authorization of laws and regulations and the subject of the personal information. For example, when the embodiments of the present disclosure are applied to a specific product or technology, such as acquiring a media object currently being played of a user, it is necessary to obtain the user's permission or consent, and the collection, use, and processing of related data need to comply with relevant laws, regulations, and standards of relevant regions.

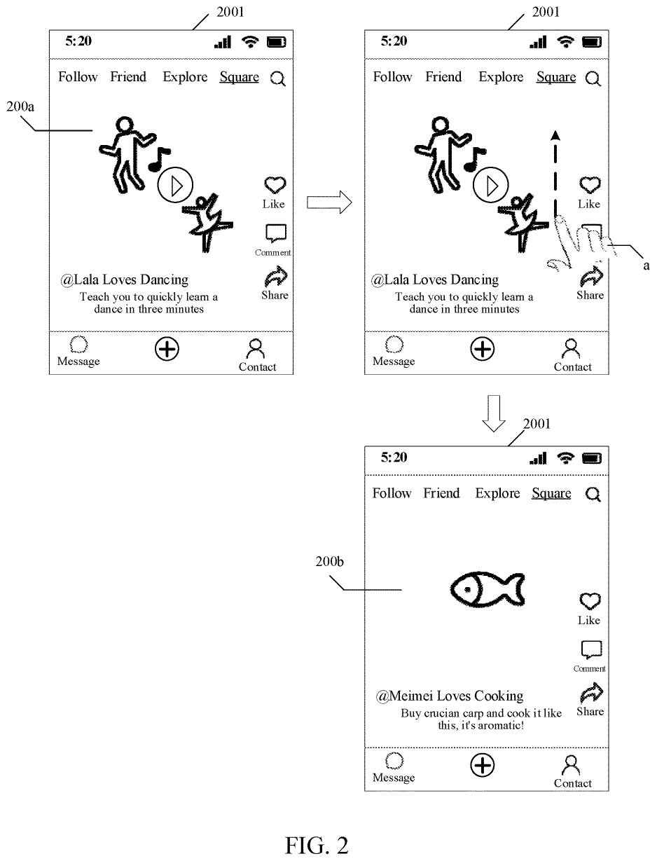

Based on the above-described solution, for ease of understanding its application scenario, refer to FIG. 2. FIG. 2 is a schematic diagram of a scenario according to an embodiment of the present disclosure. The scenario shown in FIG. 2 is a scenario for description by taking a media object being a video and a media encoding parameter being a bit rate as an example. As shown in FIG. 2, when a user a uses a short video recommendation application deployed on a terminal, the short video recommendation application may continuously recommend new videos to the user a, and the user a may request to display a new video by performing an operation of pulling a video. As shown in FIG. 2, in a video display interface 2001 of the terminal, a video currently exposed to the user is a video 200a (i.e., a video currently being played and watched by the user a is the video 200a, a creator of the video 200a is a subject named “Lala Loves Dancing”, and a video caption of the video 200a is “Teach you to quickly learn a dance in three minutes”). In the video display interface 2001, a like control, a comment control, and a share control are displayed, which can be used by the user a to like, comment on, and share the video 200a. In addition, the user a may perform a sliding operation in the video display interface 2001 to request to refresh and display a new video (a video not played or currently being played of the user a).

In practical application, a background server of a short video recommendation application may, based on videos being played or played of a user, search a database for a plurality of videos having video topics similar or identical to those of these videos (for example, video topics are all <pets>, <cooking>, <restaurant exploration>, <emotional counseling>, etc.), and transcode them. Then, a terminal preloads the transcoded videos. After the user performs an operation of pulling a video, the terminal may sequentially recommend these downloaded transcoded videos to the user for browsing and watching by the user.

For example, in the scenario shown in FIG. 2, when the user a watches the video 200a, the server may, based on historical played videos of the user a (historical played videos refer to videos played and watched by the user a before playing the video 200a), find 5 videos to be recommended to the user a. For these 5 videos, they may be sorted according to a certain sorting rule (such as a random sorting rule), thereby obtaining a video sequence. The embodiments of the present disclosure may transcode each video in the sequence. These 5 videos will be sequentially exposed and played to the user after the user continuously performs the operation of pulling a video. To reduce a problem of video quality jump during continuous playing of these 5 videos, so as to improve overall playback quality of these 5 videos in a playing process, the embodiments of the present disclosure may dynamically optimize a bit rate of the videos based on a predicted network speed and a video quality of each video, so that the video quality after transcoding can be better.

In one embodiment, the server may acquire a historical time period (such as previous 5 s) of a time point (i.e., a current playing time point) when the video 200a is currently played, and determine an average network speed of the historical time period based on network speeds at each historical time point in the historical time period (for example, the 1^{st} second, the 2^{nd} second, the 3^{rd} second, the 4^{th} second, and the 5^{th} second within the previous 5 s). The average network speed may serve as a predicted network speed for subsequently playing the above 5 preloaded videos. Then, the server may invoke a trained bit rate prediction model, and input a video content of each video (such as a data size of the video, a buffering duration, and a number of scenarios included in the video) and the predicted network speed into the bit rate prediction model. In the bit rate prediction model, under a constraint of the predicted network speed, the video content of each video may be analyzed. Finally, a maximum bit rate of each video that is not greater than the predicted network speed and adapted to the video content of the video itself may be obtained through analysis, and the maximum bit rate may serve as an initial bit rate of the video. Further, the server may acquire a video quality of each video at its own corresponding initial bit rate (i.e., a quality obtained after transcoding the video by adopting the initial bit rate). Based on each video quality, a video whose video quality does not satisfy a preset quality condition may be determined. In the embodiments of the present disclosure, the preset quality condition may refer to a condition that a video quality cannot be too high or too low. In this scenario, for each video sequence to be played, the server may, by default, designate both a video with a highest video quality and a video with a lowest video quality as videos that do not satisfy the preset quality condition.

Further, for a video that does not satisfy the preset quality condition, since the video quality thereof is too high or too low, in a process of playing the video sequence in order, the video quality will be alternately low and high, affecting viewing experience. Then, the present disclosure may adjust an initial bit rate of the video under a constraint of a predicted network speed, so as to adjust the video quality thereof to obtain a video satisfying the preset quality condition. Specifically, whether the initial bit rate of the video satisfies an adjustment condition may be determined based on the predicted network speed. For example, for a video with a lowest video quality, it may be determined whether the initial bit rate thereof can still be adjusted up, and whether the predicted network speed can drive after the bit rate is adjusted up. If it is determined that the initial bit rate can be adjusted up, and the predicted network speed can also drive after the bit rate is adjusted up, then it may be determined that the initial bit rate satisfies the adjustment condition, and the initial bit rate of the video with the lowest video quality may be adjusted up (for example, the initial bit rate is adjusted up by one bit rate level). For another example, for a video with a highest video quality, it may be determined whether the initial bit rate thereof can still be adjusted down. If it is determined that the initial bit rate satisfies the adjustment condition, then the initial bit rate of the video with the highest video quality may be adjusted down (for example, the initial bit rate is adjusted down by one bit rate level).

Through the above bit rate adjustment, the initial bit rate of the video whose video quality does not satisfy the preset quality condition can be adjusted up or down, so that the video quality thereof can satisfy the preset quality condition. The server may transcode each video respectively based on the final bit rate of each video, and after obtaining transcoded videos, transmit a transcoded video sequence to the terminal. Then, after the user a performs an operation of pulling a video, the terminal may update and display, in the video display interface 2001, a video from the video 200a to a video arranged first in the video sequence. For example, as shown in FIG. 2, assuming that a video sequence to be played is {video 200b, video 200c, video 200d, video 200e, video f}, when the user a performs a sliding operation in the video display interface 2001 (a sliding direction is a direction indicated by an arrow as shown in FIG. 2), the terminal may, in response to this sliding operation, update and display, in the video display interface 2001, a video to a transcoded video 200b (a creator of the video 200b is a subject named “Meimei Loves Cooking”, and a video caption of the video 200b is “Buy crucian carp and cook it like this, it's aromatic!”). If the user a performs a sliding operation again in the video display interface 2001 (the sliding direction is the direction indicated by the arrow as shown in FIG. 2), the terminal may, in response to this sliding operation, update and display the video displayed in the video display interface 2001 to a video 200c. That is to say, the user may request to update and display a new video by continuously performing a sliding operation. When the user a plays and browses a video 200f, the server may obtain a new batch of videos again, sort them as a video sequence to be played of the user a, then determine a predicted network speed of the sequence of this batch of videos, determine an initial bit rate of each video according to the new predicted network speed, and then dynamically optimize the initial bit rate of the video based on a video quality of each video at the initial bit rate. A video sequence after bit rate optimization may be transmitted to the terminal again, and the terminal preloads the video sequence, so as to satisfy that each video satisfying the preset quality condition can be quickly viewed after the user a performs a sliding operation.

Based on the above-described solution and application scenarios, the embodiments of the present disclosure propose a more detailed method for dynamically adjusting a media encoding parameter. The method for dynamically adjusting the media encoding parameter proposed in the embodiments of the present disclosure will be described in detail below with reference to the accompanying drawings.

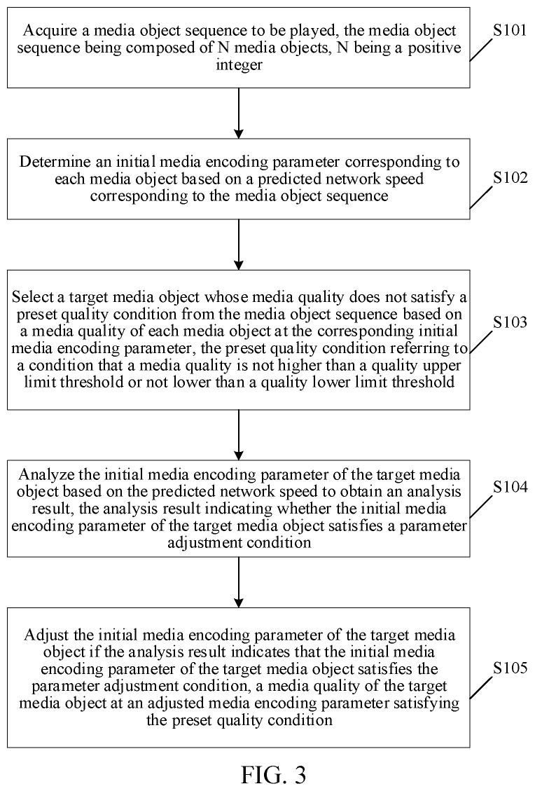

Refer to FIG. 3. FIG. 3 is a schematic flowchart of a data processing method according to an exemplary embodiment of the present disclosure. This flowchart may refer to a process of dynamically adjusting a media encoding parameter provided in the embodiment of the present disclosure. The data processing method (the method for dynamically adjusting the media encoding parameter) may be executed by a computer device in the above system, such as the computer device being a terminal and/or a server. The data processing method may at least include the following operations S101 to S105:

Operation S101: Acquire a media object sequence to be played, the media object sequence being composed of N media objects, N being a positive integer.

In the present disclosure, a media object sequence to be played may refer to a media object sequence waiting to be played. The media object sequence may include N (N may be a positive integer, i.e., one or more) media objects, and the N media objects are sorted according to a specified playing order, thereby forming a media object sequence. In practical application, a media object may refer to a video, and the video may include text or audio. In one embodiment, acquiring a media object to be played may include but are not limited to the following: 1) when a user watches a certain episode of a TV series, a certain variety show, or a certain movie on a video playback platform, video blocks of several subsequent time periods after a time period currently watched by the user may be used as several videos to be played, and then a video sequence is formed by composing the video blocks according to a playing order. The video sequence may serve as a media object sequence. For example, when a user is playing a video of the 0 second to the 5^{th} second of a TV series “BCBC Episode 01”, video blocks of the 5^{th} second to the 10^{th} second, the 10^{th} second to the 15^{th} second, and the 15^{th} second to the 20^{th} second of Episode 01 may be acquired. These three video blocks may all serve as videos to be played, and may be sorted according to a chronological order of playing times corresponding to each video to obtain a video sequence. 2) N similar videos (such as videos with the same video topic) of a video currently being played of the user are acquired, a playing order for the N similar videos is specified, and the N similar videos are sorted in order to obtain a video sequence. For example, when a user watches a video in a short video recommendation application, based on historical played videos of the user, N similar videos (similar videos may refer to videos with similar video topics or similar video content) may be acquired, and the N similar videos are all used as videos to be played. Then, the N similar videos may be sorted according to a playing order to obtain a video sequence. The embodiment of the present disclosure does not limit a mode for actually acquiring a media object sequence to be played. In other words, the embodiment of the present disclosure does not limit a scenario to which this solution is applied.

Operation S102: Determine an initial media encoding parameter corresponding to each media object based on a predicted network speed corresponding to the media object sequence.

In the present disclosure, for a media object sequence to be played, a network speed for playing the media object sequence may be predicted based on a network condition (such as a network speed) of a historical time period. Here, the historical time period may refer to a time period earlier than a time when a current media object is played, which may be understood as a time period earlier than a time moment when the media object sequence is played. For example, when a user plays a certain media object, a media object currently being played may be referred to as a current media object, and a time point when the current media object is played is determined as a current playing time point. Then, the historical time period may be a time period earlier than the current playing time point. The closer a historical time period is to the current playing time point, the more similar a network condition of the historical time period is to a network condition when the media object sequence is played. Therefore, when determining the historical time period, the embodiment of the present disclosure may select a time period closer to the current playing time point (such as previous 10 s, previous 5 s, and previous 3 s of the current playing time point) as the historical time period, and then predict, based on a network speed of the historical time period, a network speed for playing the media object sequence. The predicted network speed for playing the media object sequence may be referred to as a predicted network speed of the media object sequence in the present disclosure. Then, the predicted network speed may be used as a constraint value, so as to analyze and determine, under a constraint of the predicted network speed of the media object sequence and based on media content of each media object itself, a media encoding parameter adapted to the media content of the media object itself for each media object, and the media encoding parameter may serve as an initial media encoding parameter of the media object.

In the present disclosure, the media encoding parameter may refer to an encoding parameter configured for encoding a media object for transcoding, which may specifically include, but is not limited to, a bit rate, a resolution, and a frame rate.

In one embodiment, one exemplary embodiment for determining an initial media encoding parameter of each media object based on a predicted network speed corresponding to a media object sequence includes, but is not limited to, acquiring an average network speed of a historical time period, and determining the average network speed of the historical time period as the predicted network speed of the media object sequence. Based on the above, a network speed for playing a media object sequence may be predicted based on a network speed of a historical time period. The embodiment of the present disclosure may adopt an average network speed of a historical time period as a predicted network speed for playing a media object sequence. One exemplary embodiment for acquiring an average network speed of a historical time period may include, but is not limited to, acquiring a time sampling rule, and sampling T time points from the historical time period according to the time sampling rule, T being a positive integer (usually a positive integer greater than or equal to 2). The time sampling rule here may be set manually. For example, the time sampling rule may be a random sampling rule (i.e., randomly sampling T time points from the historical time period), or may be a sampling rule of sampling one time point every 1 s (i.e., sampling one time point from the historical time period every 1 s). The embodiment of the present disclosure does not limit the specific time sampling rule. Then, historical network speeds respectively corresponding to each of the T time points may be acquired (i.e., network speeds of a user at each time point of the historical time period when playing a historical video), thereby obtaining T historical network speeds. For these T historical network speeds, an average value may be calculated, and the average value may serve as the average network speed of the historical time period. For ease of intuitively understanding the example implementation process for obtaining the average network speed of the historical time period, refer to formula (1). The specific process for obtaining the average network speed of the historical time period may be as shown in formula (1):

$${V}_{avg} = ( \sum {V}_{n} ) / T \qquad Formula ( 1 )$$

where Vₙ in formula (1) may be configured for representing a historical network speed corresponding to an n^{th} time point in the historical time period (a result obtained by performing network speed measurement on the n^{th} time point); Vdavg in formula (1) is configured for representing an average network speed of the historical time period (an average predicted bandwidth); and T may be configured for representing a total number of time points sampled in the historical time period.

The above way of determining the average network speed of the historical time period by calculating the average value is merely an example. The embodiment of the present disclosure does not limit a way for actually acquiring the average network speed of the historical time period. For example, a time-weighted calculation may also be adopted to obtain the average network speed of the historical time period. A specific process may be as shown in formula (2):

$${V}_{avg} = \sum {ω}_{n} {V}_{n} \qquad Formula ( 2 )$$

where Vₙ in formula (2) may be configured for representing a historical network speed corresponding to an n^{th} time point in the historical time period (a result obtained by performing network speed measurement on the n^{th} time point); ωₙ may refer to a weight value corresponding to Vₙ, and Σωₙ=1 (i.e., a sum of weight values corresponding to historical network speeds at each time point in the historical time period is to equal 1). A certain ωₙ may be adjusted according to experience. For example, the closer a time point is to a current playing time point, the larger a weight value ωₙ of a historical network speed corresponding to the time point is to be. For example, assuming that three time points are sampled, namely time point 1, time point 2, and time point 3, with time point 1 being earlier than time point 2, and time point 2 being earlier than time point 3. Then, a weight value of a historical network speed corresponding to time point 1 is to be the smallest (for example, 0.2); a weight value of a historical network speed corresponding to time point 3 is to be the largest (for example, 0.5); and a weight value of a historical network speed corresponding to time point 2 may be 0.3. By adopting the above formula (2), the average network speed of the historical time period can be determined.

Further, after determining the predicted network speed of the media object sequence, K (K being a positive integer) configured media encoding parameters may be acquired. In the present disclosure, a configured media encoding parameter may refer to a media encoding parameter configured for each media object. Each configured media encoding parameter may have a different value, and different values may correspond to different levels (for example, the larger the value, the higher the level). Therefore, for the K configured media encoding parameters, parameter levels corresponding to each configured media encoding parameter are all different, i.e., parameter levels to which any two configured media encoding parameters belong are different from each other. For example, when a media encoding parameter is a bit rate, 360, 480, 600, 720, and 1080 may be used as configured bit rates. Then, any media object in the media object sequence may be determined as an analysis media object (i.e., referred to as an analysis media object). Based on the above predicted network speed, parameter adaptation analysis may be performed on the analysis media object, so as to select, from the K configured media encoding parameters, an initial media encoding parameter of the analysis media object. That is to say, each media object in the media object sequence serves as an analysis media object, and then parameter adaptation analysis is performed on each media object to analyze and obtain an initial media encoding parameter adapted to each media object.

A specific process of performing parameter adaptation analysis on any media object may be implemented by a trained parameter prediction model. The parameter prediction model may differ based on different media encoding parameters. For example, when the media encoding parameter is a bit rate, the parameter prediction model may be a bit rate prediction model. The parameter prediction model may include a network structure of RNN, CNN, or ResNet, and has a prediction capability. With training through machine learning, the model can be enabled to predict, based on media content of a media object and from the K configured media encoding parameters, a media encoding parameter adapted to media content of the media object itself. In one embodiment, one exemplary embodiment for determining an initial media encoding parameter of each media object based on a predicted network speed corresponding to a media object sequence may include, but is not limited to, the following. Taking any media object as an example here, this media object may be referred to as an analysis media object. In a process of determining an initial media encoding parameter of the analysis media object, a media content of the analysis media object may be acquired, and a parameter prediction model is invoked based on the media content (the parameter prediction model is pre-trained, and the above K configured media encoding parameters are deployed in the parameter prediction model). Then, through the parameter prediction model, comprehensive analysis may be performed on the media content of the analysis media object and the predicted network speed, and finally a predicted media encoding parameter adapted to the media content of the analysis media object is output. Performing comprehensive analysis on the media content of the analysis media object and the predicted network speed means performing calculation and analysis on the media content of the analysis media object under a constraint of the predicted network speed, so as to output a predicted media encoding parameter adapted to the media content, and the predicted media encoding parameter is not greater than the predicted network speed. For example, if a media content of a certain analysis media object is relatively simple, then a relatively high media quality may be obtained by transcoding the analysis media object using any media encoding parameter. In this case, a predicted media encoding parameter of the analysis media object may be a largest configured media encoding parameter in configured media encoding parameters not greater than a predicted network speed. Finally, the predicted media encoding parameter of the analysis media object may be determined as an initial media encoding parameter of the analysis media object. Each media object may be used as an analysis media object once, and then an initial media encoding parameter may be analyzed for each media object by adopting the above way.

Operation S103: Select a target media object whose media quality does not satisfy a preset quality condition from the media object sequence based on a media quality of each media object at the corresponding initial media encoding parameter, satisfying the preset quality condition referring to a media quality being not higher than a quality upper limit threshold or not lower than a quality lower limit threshold.

In the present disclosure, after determining the initial media encoding parameter corresponding to each media object in the media object sequence, for any media object, a media quality of the media object at its own corresponding initial media encoding parameter may be acquired (i.e., a quality obtained after transcoding the media object by adopting the initial media encoding parameter, which is usually determined by indicators such as definition and aesthetics of the transcoded media object. In the present disclosure, a media quality may refer to a specific score value, i.e., the present disclosure may determine a presentation effect of each media object under indicators such as definition and aesthetics at its own corresponding initial media encoding parameter. Based on the presentation effect under these indicators, quality evaluation may be performed on the media object to obtain a quality score value of the media object, and the quality score value may serve as a media quality of the media object). According to a media quality of each media object at its own corresponding initial media encoding parameter (i.e., the corresponding initial media encoding parameter), a media object whose media quality does not satisfy a preset quality condition may be selected, and these media objects may be referred to as target media objects in the present disclosure.

In the present disclosure, the preset quality condition may refer to a condition that a media quality cannot be too high (for example, cannot be higher than a quality upper limit threshold, which may be specifically set based on actual service requirements; usually, a relatively high score value may be selected as the quality upper limit threshold, for example, 98 points may be selected as the quality upper limit threshold) or cannot be too low (for example, cannot be lower than a quality lower limit threshold, which may be specifically set based on actual service requirements; usually, a score value far lower than the quality upper limit threshold may be selected as the quality lower limit threshold, for example, 70 points may be selected as the quality lower limit threshold). The quality upper limit threshold and the quality lower limit threshold may be set manually, but a difference between the quality upper limit threshold and the quality lower limit threshold is usually set to a relatively large value. In the embodiment of the present disclosure, for a media object sequence to be played, a computer device (such as a server) usually first performs transcoding based on a media encoding parameter, and then a playback end (such as a terminal) preloads these transcoded media objects (i.e., pre-downloads them to a local database of the playback end) for subsequent quick playback. For a media object sequence to be played, initial media encoding parameters corresponding to different media objects may be different, and media qualities after transcoding at the corresponding initial media encoding parameters may also be different. For example, for some media objects with relatively complex media content, under a condition of a relatively low predicted network speed, due to a constraint of the predicted network speed, an initial media encoding parameter thereof may be relatively low. Then, after transcoding with the relatively low initial media encoding parameter, an obtained media quality is also relatively low, and a media quality when the terminal plays the media object is not high enough. For example, definition may be relatively low (e.g., some textures are blurred, or lines are blurred). To ensure as high as possible the media quality when the media object is played (i.e., to improve definition, aesthetics or the like when the media object is played), it is necessary to increase levels of media encoding parameters of these media objects as much as possible, so as to improve media qualities thereof after transcoding. Based on this, the embodiment of the present disclosure may use a media object with a relatively low media quality obtained at an initial media encoding parameter (i.e., a media object whose media quality is lower than a quality lower limit threshold) as a media object whose media encoding parameter is to be adjusted (i.e., as a target media object). Meanwhile, since the initial media encoding parameter of the media object with the low media quality is adjusted (adjusted up, i.e., a parameter level of the media encoding parameter is adjusted up), an up-adjusted media encoding parameter thereof may be greater than the predicted network speed. Therefore, for an entire media object sequence, during the preloading process at the playback end, an average value of media encoding parameters of the entire media object sequence (i.e., an average media encoding parameter) may fluctuate relatively greatly.

For example, for a video sequence composed of 4 videos, after determining initial bit rates of each video, if an initial bit rate of a video with a lowest video quality at the initial bit rate is adjusted up (for example, the initial bit rate is adjusted up, where an up-adjusted bit rate is one bit rate level higher than the initial bit rate), then since the initial bit rate of each video refers to a maximum selectable bit rate under a condition of not being greater than a predicted network speed, the up-adjusted bit rate may be greater than the predicted network speed. Thus, it can be seen that by adjusting up a bit rate of a low-quality video, for an average bit rate of these 4 videos during a preloading process at a terminal, relatively great fluctuation occurs, and a bandwidth for downloading thereof also changes relatively significantly. To balance the average media encoding parameter of the media object sequence during the preloading process, so that the playback end can quickly complete preloading under the constraint of the predicted network speed, thereby reducing a situation of playback freeze during playing of a media object (since some media objects are not preloaded completely, smooth playing cannot be achieved, thus causing playback freeze), the embodiment of the present disclosure may, after adjusting up the initial media encoding parameter of the media object with the low media quality, simultaneously appropriately adjust down an initial media encoding parameter of a media object with a high media quality (such as a media object whose media quality at a corresponding initial media encoding parameter is higher than a quality upper limit threshold in the media object sequence) (a parameter level of a down-adjusted media encoding parameter is lower than that of the initial media encoding parameter). Since these media objects have relatively high media quality, corresponding media encoding parameters thereof are also relatively high. Therefore, even if the initial media encoding parameter is appropriately adjusted down, the media qualities of these media objects does not decrease too much, and definition thereof remains relatively high. By adopting the above way, while media encoding parameters of some media objects in the media object sequence can be adjusted up, media encoding parameters of another part of media objects are appropriately adjusted down. A sum of media encoding parameters of the entire media object sequence does not change significantly, and the average media encoding parameter during the preloading process also does not fluctuate significantly. Then, during the preloading process at the playback end, a download bandwidth does not change significantly, and preloading can be smoothly and quickly completed under the constraint of the predicted network speed, so as to reduce a situation of playback freeze during the playing process.

In summary, in the present disclosure, while adjusting up the media encoding parameter of the media object with the low media quality, it is necessary to adjust down the media encoding parameter of the media object with the high media quality. Then, in the present disclosure, a preset quality condition may be set as a condition that a media quality cannot be too high (e.g., higher than a quality upper limit threshold) and cannot be too low (e.g., lower than a quality lower limit threshold). Therefore, the target media object whose media quality does not satisfy a preset quality condition in a media object sequence may refer to a media object whose media quality at corresponding initial media encoding parameters is higher than the quality upper limit threshold in the media object sequence, and a media object whose media quality is lower than the quality lower limit threshold. In the embodiment of the present disclosure, the target media object that does not satisfy the preset quality condition in the media object sequence may be specially set. Specifically, a media object with a highest media quality at a corresponding initial media encoding parameter in the media object sequence may be specially defaulted as a media object with too high media quality, and a media object with a lowest media quality at a corresponding initial media encoding parameter may be specially defaulted as a media object with too low media quality, i.e., for any media object sequence, after determining a media quality of each media object at a corresponding initial media encoding parameter, a media object with a highest media quality and a media object with a lowest media quality may be defaulted as target media objects that do not satisfy the preset quality condition. Then, based on a subsequent analysis rule, whether the media qualities of these two target media objects actually satisfy the preset quality condition is analyzed and determined. In general, the preset quality condition in the present disclosure may be determined based on media qualities of each media object in a media object sequence at a corresponding initial media encoding parameter. Specifically, a quality upper limit threshold may be determined based on a highest media quality in the media object sequence. The quality upper limit threshold may be lower than the highest media quality in the media object sequence (while being higher than a second highest media quality in the media object sequence). In this way, the media object with the highest media quality may be considered as a target media object that does not satisfy the preset quality condition. Similarly, a quality lower limit threshold may be determined based on a lowest media quality in the media object sequence. The quality lower limit threshold may be higher than the lowest media quality in the media object sequence (while being lower than a second lowest media quality in the media object sequence). In this way, the media object with the lowest media quality may be considered as a target media object that does not satisfy the preset quality condition. By flexibly setting the quality upper limit threshold and the quality lower limit threshold based on each media object sequence in this way, the target media objects whose media qualities do not satisfy the preset quality condition in each media object sequence may be determined to be a media object with a highest media quality and a media object with a lowest media quality in the media object sequence.

Operation S104: Analyze the initial media encoding parameter of the target media object based on the predicted network speed to obtain an analysis result, the analysis result indicating whether the initial media encoding parameter of the target media object satisfies a parameter adjustment condition.

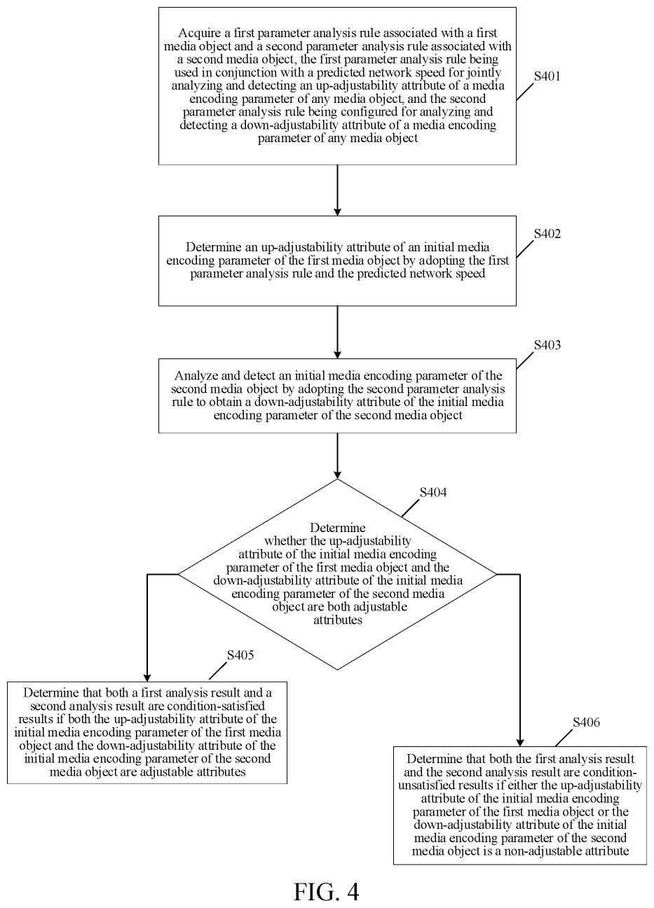

In the present disclosure, after determining the target media object whose media quality does not satisfy a preset quality condition, whether an initial media encoding parameter of the target media object actually satisfies a parameter adjustment condition may be analyzed and determined. If satisfied, the initial media encoding parameter may be adjusted. In one embodiment, for the target media object with the lowest media quality, whether the initial media encoding parameter of the target media object can be appropriately adjusted up needs to be analyzed under the constraint of the predicted network speed. For the target media object with the highest media quality, after verifying that the target media object indeed does not satisfy the preset quality condition, whether the initial media encoding parameter of the target media object can be appropriately adjusted down needs to be analyzed based on a corresponding analysis rule. Here, the parameter adjustment condition may be understood as whether an initial media encoding parameter of a target media object conforms to a corresponding analysis rule. If the initial media encoding parameter conforms to the corresponding analysis rule, it may be considered that the parameter adjustment condition is satisfied. Only when it is determined that both initial media encoding parameters can be adjusted can an initial media encoding parameter of a target media object with low media quality be appropriately adjusted up, and simultaneously an initial media encoding parameter of a target media object with high media quality be appropriately adjusted down. In other words, the initial media encoding parameter of the target media object with the low media quality cannot be adjusted up alone. For one exemplary embodiment of analyzing the initial media encoding parameter of the target media object based on the predicted network speed to obtain the analysis result, a reference may be made to a description in a corresponding embodiment in subsequent FIG. 4.

Operation S105: Adjust the initial media encoding parameter of the target media object in response to the analysis result indicating that the initial media encoding parameter of the target media object satisfies the parameter adjustment condition, a media quality of the target media object at an adjusted media encoding parameter satisfying the preset quality condition.

In the present disclosure, for ease of distinction, the media object with the lowest media quality may be referred to as a first media object, and the media object with the highest media quality may be referred to as a second media object. Then, an analysis result of the target media object includes an analysis result of the first media object (which may be referred to as a first analysis result) and an analysis result of the second media object (which may be referred to as a second analysis result). Both the first analysis result and the second analysis result may include a condition-satisfied result and a condition-unsatisfied result. The condition-satisfied result may be configured for indicating that the initial media encoding parameter satisfies the parameter adjustment condition, and the condition-unsatisfied result may be configured for indicating that the initial media encoding parameter does not satisfy the parameter adjustment condition. Then, if the first analysis result is a condition-satisfied result, it may indicate that the initial media encoding parameter of the first media object satisfies the parameter adjustment condition. In this case, the initial media encoding parameter of the first media object may be adjusted (adjusted up). If the first analysis result is a condition-unsatisfied result, it may indicate that the initial media encoding parameter of the first media object does not satisfy the parameter adjustment condition. In this case, the initial media encoding parameter of the first media object cannot be adjusted, and needs to be retained. Similarly, if the second analysis result is a condition-satisfied result, it may indicate that the initial media encoding parameter of the second media object satisfies the parameter adjustment condition. In this case, the initial media encoding parameter of the second media object may be adjusted (adjusted down). If the second analysis result is a condition-unsatisfied result, it may indicate that the initial media encoding parameter of the second media object does not satisfy the parameter adjustment condition. In this case, the initial media encoding parameter of the second media object cannot be adjusted, and needs to be retained.

Whether the initial media encoding parameter is adjusted down or adjusted up, an adjustment amplitude thereof is not to be too large. This is because the initial media encoding parameter is a largest configured media encoding parameter determined under the constraint of the predicted network speed. If an adjustment-up amplitude is too large, the predicted network speed may fail to drive, resulting in slow preloading and a problem of playback freeze. Here, when adjusting up the initial media encoding parameter, a configured media encoding parameter one parameter level higher may be selected from configured media encoding parameters as an adjusted-up media encoding parameter. In this way, a difference between the adjusted-up media encoding parameter and the predicted network speed is not too large, which can reduce the situation where the predicted network speed fails to drive the adjusted media encoding parameter, causing slow downloading and thus playback freeze. By adjusting up the media encoding parameter, the media quality of the media object can also be improved, and the adjusted-up media quality may be defaulted as satisfying the preset quality condition. Similarly, when adjusting down the initial media encoding parameter, a configured media encoding parameter one parameter level lower may be selected from the configured media encoding parameters as an adjusted-down media encoding parameter. In this way, the media quality of the media object after the media encoding parameter is adjusted down will not remain at a relatively high level, and the adjusted-down media quality can satisfy the preset quality condition.

In summary, it can be seen that the embodiment of the present disclosure can allocate, under the constraint of the predicted network speed, the media encoding parameter adapted to the media content of each media object itself to different media objects, and can dynamically optimize, under the constraint of the predicted network speed, the media encoding parameter of the media object that does not satisfy the preset quality condition in the media object sequence, so that the media encoding parameter can satisfy the preset quality condition, thereby improving or enhancing the overall playback quality of the media object sequence, i.e., the embodiment of the present disclosure can combine the media quality of the media object and dynamically optimize the media encoding parameter of the media object under the constraint of the predicted network speed. Compared with a one-size-fits-all media encoding parameter adjustment, the embodiment of the present disclosure can improve the overall playback quality of the media object sequence while reducing the situation of playback freeze during the playing process.

Further, for ease of understanding one exemplary embodiment of analyzing the initial media encoding parameter of the above target media object, refer to FIG. 4. FIG. 4 is a schematic flowchart of analyzing an initial media encoding parameter according to an embodiment of the present disclosure. The process may correspond to one exemplary embodiment, in this embodiment corresponding to FIG. 3 above, of analyzing an initial media encoding parameter of a target media object based on a predicted network speed to obtain an analysis result. As shown in FIG. 4, the process may at least include the following operations S401 to S406:

Operation S401: Acquire a first parameter analysis rule associated with the first media object and a second parameter analysis rule associated with the second media object, the first parameter analysis rule being used in conjunction with the predicted network speed for jointly analyzing and detecting an up-adjustability attribute of a media encoding parameter of any media object, and the second parameter analysis rule being configured for analyzing and detecting a down-adjustability attribute of a media encoding parameter of any media object.

Specifically, the embodiment of the present disclosure may configure different parameter analysis rules for a media object whose media quality is higher than a quality upper limit threshold (in the embodiment of the present disclosure, the media object is defaulted as a media object with a highest media quality in the media object sequence) and a media object whose media quality is lower than a quality lower limit threshold (in the embodiment of the present disclosure, the media object is defaulted as a media object with a lowest media quality in the media object sequence). Then, after determining the media object with the lowest media quality and the media object with the highest media quality, initial media encoding parameters thereof may be analyzed according to corresponding parameter analysis rules. For example, for the media object with the lowest media quality, whether the initial media encoding parameter thereof can be adjusted up may be analyzed under the constraint of the predicted network speed according to the corresponding parameter analysis rule. For the media object with the highest media quality, since the media encoding parameter thereof needs to be adjusted down, the predicted network speed can definitely drive an adjusted-down media encoding parameter. Therefore, reference to the predicted network speed is unnecessary, and it is only needed to analyze, according to the corresponding parameter analysis rule, whether the initial media encoding parameter thereof can be adjusted down.

Based on this, after acquiring the first media object and the second media object, a first parameter analysis rule associated with the first media object may be further acquired (i.e., a parameter analysis rule configured and set for the media object with the lowest media quality, mainly used in conjunction with the predicted network speed for jointly analyzing and detecting the up-adjustability attribute of the media encoding parameter of any media object. The up-adjustability attribute is configured for indicating whether the media encoding parameter can be adjusted up. Specifically, the up-adjustability attribute of the media encoding parameter includes an adjustable attribute and a non-adjustable attribute. The adjustable attribute in the up-adjustability attribute may indicate that up adjustment can be performed, and the non-adjustable attribute in the up-adjustability attribute may indicate that up adjustment cannot be performed), and a second parameter analysis rule associated with the second media object may be further acquired (i.e., a parameter analysis rule configured and set for the media object with the highest media quality, mainly configured for analyzing and detecting the down-adjustability attribute of the media encoding parameter of any media object. Specifically, the down-adjustability attribute of the media encoding parameter includes an adjustable attribute and a non-adjustable attribute. The adjustable attribute in the down-adjustability attribute may indicate that down adjustment can be performed, and the non-adjustable attribute in the down-adjustability attribute may indicate that down adjustment cannot be performed). This is to subsequently determine, based on the first parameter analysis rule, whether the media encoding parameter of the first media object can be adjusted up, and determine, based on the second parameter analysis rule, whether the media encoding parameter of the second media object can be adjusted down.

That is to say, when the target media object whose media quality does not satisfy a preset quality condition is the first media object, analyzing parameter adjustability of the target media object refers to analyzing whether the first media object has up-adjustability; and when the target media object whose media quality does not satisfy a preset quality condition is the second media object, analyzing parameter adjustability of the target media object refers to analyzing whether the second media object has down-adjustability.

Operation S402: Analyze and detect the up-adjustability attribute of the initial media encoding parameter of the first media object by adopting the first parameter analysis rule and the predicted network speed to obtain the up-adjustability attribute of the initial media encoding parameter of the first media object.

Specifically, based on the above, the first parameter analysis rule and the predicted network speed may be adopted to analyze whether the initial media encoding parameter of the first media object can be adjusted up. If the first media object conforms to each criterion included in the first parameter analysis rule, then it may be considered that the initial media encoding parameter of the first media object conforms to the first parameter analysis rule, and it may be considered that, after analysis based on the first parameter analysis rule, the first media object is determined to be capable of being subject to up adjustment of the media encoding parameter. Here, an analysis result obtained by adopting the first parameter analysis rule for analysis may be determined as an analysis result of the up-adjustability attribute of the initial media encoding parameter. The up-adjustability attribute is to include an adjustable attribute and a non-adjustable attribute. The adjustable attribute may indicate that the initial media encoding parameter of the first media object conforms to the first parameter analysis rule, the initial media encoding parameter of the first media object satisfies a parameter adjustment condition, and the initial media encoding parameter of the first media object can be adjusted up. The non-adjustable attribute may indicate that the initial media encoding parameter of the first media object does not conform to the first parameter analysis rule, the initial media encoding parameter of the first media object does not satisfy the parameter adjustment condition, and the initial media encoding parameter of the first media object cannot be adjusted up.

In one embodiment, one exemplary embodiment for analyzing and detecting the up-adjustability attribute of the initial media encoding parameter of the first media object by adopting the first parameter analysis rule and the predicted network speed to obtain the up-adjustability attribute of the first media object may include but is not limited to the following: for ease of distinction, the initial media encoding parameter of the first media object may be first determined as a first initial encoding parameter, and a media quality of the first media object at the first initial encoding parameter may be determined as a first media quality. Then, according to the first parameter analysis rule, the first media quality may be compared with a quality lower limit threshold, to determine whether the first media quality is actually lower than the quality lower limit threshold (i.e., whether the first media quality actually satisfies the preset quality condition). A comparison result may be obtained through comparison (which may be referred to as a first comparison result here, and the first comparison result is to include a result that the first media quality is lower than the quality lower limit threshold, and a result that the first media quality is higher than the quality lower limit threshold). Further, the above K configured media encoding parameters may be acquired. Based on the first initial encoding parameter, the K configured media encoding parameters may be traversed, to query whether there is a configured media encoding parameter whose parameter level is higher than a parameter level of the first initial encoding parameter in the K configured media encoding parameters. Since the initial media encoding parameter of the first media object needs to be adjusted up to improve the media quality thereof, if there is no configured media encoding parameter whose parameter level is higher than the parameter level of the first initial encoding parameter in the K configured media encoding parameters, then the first initial encoding parameter cannot be adjusted up, because it is already the largest value of the media encoding parameter in the configured media encoding parameters. If there are configured media encoding parameters with higher parameter levels in the K configured media encoding parameters, the present disclosure may use them as candidate up-adjusted media encoding parameters, and select, from the candidate up-adjusted media encoding parameters, the smallest one as an up-adjusted media encoding parameter for this adjustment (i.e., a parameter level of the up-adjusted media encoding parameter is only one level higher than a parameter level of the first initial encoding parameter). Then, whether the first initial encoding parameter can be adjusted up to the up-adjusted media encoding parameter may be analyzed based on the predicted network speed. Specifically, a difference between the predicted network speed and the up-adjusted media encoding parameter may be first calculated (for example, a difference between the predicted network speed and a bit rate is calculated), and then the up-adjustability attribute of the initial media encoding parameter of the first media object is jointly determined based on the difference and the above first comparison result.

One exemplary embodiment for determining the up-adjustability attribute of the initial media encoding parameter of the first media object based on the difference between the predicted network speed and the up-adjusted media encoding parameter, and the first comparison result may include but is not limited to the following: the difference between the predicted network speed and the up-adjusted media encoding parameter may be compared with a difference threshold (the difference threshold may be set manually. Usually, the difference threshold is set to a relatively small value, so as to ensure that the up-adjusted media encoding parameter does not exceed the predicted network speed by too much, thereby reducing the situation where preloading cannot be completed in time, causing playback freeze). If the difference between the predicted network speed and the up-adjusted media encoding parameter is less than the difference threshold, and the above first comparison result is a result that the first media quality is less than the quality lower limit threshold, then it may be considered that the first media quality indeed does not satisfy the preset quality condition, and meanwhile the up-adjusted media encoding parameter does not exceed the predicted network speed by too much. In this case, the up-adjustability attribute of the initial media encoding parameter of the first media object may be determined as an adjustable attribute. Conversely, if the difference between the predicted network speed and the up-adjusted media encoding parameter is greater than the difference threshold, or the above first comparison result is a result that the first media quality is greater than the quality lower limit threshold, then it may be considered that the first media quality satisfies the preset quality condition, or the first media quality does not satisfy the preset quality condition but the up-adjusted media encoding parameter exceeds the predicted network speed by too much. In either case, the initial media encoding parameter of the first media object cannot be adjusted up, and the up-adjustability attribute of the initial media encoding parameter of the first media object may be determined as a non-adjustable attribute.

The above analysis process is a series of analysis processes executed under a condition that it is determined that there are configured media encoding parameters with higher parameter levels in the K configured media encoding parameters. If it is determined through traversal that there are no configured media encoding parameters with higher parameter levels in the K configured media encoding parameters, then even if the first initial encoding parameter is adjusted up, there is no selectable configured media encoding parameter as an adjusted-up media encoding parameter. In this case, the up-adjustability attribute of the initial media encoding parameter of the first media object may be directly determined as a non-adjustable attribute. In general, for the first media object, a parameter adjustment condition of the initial media encoding parameter thereof means that the parameter is to satisfy a condition of the first parameter analysis rule. If the parameter does not satisfy the first parameter analysis rule, then the parameter does not satisfy the parameter adjustment condition either.

Operation S403: Analyze and detect the initial media encoding parameter of the second media object by adopting the second parameter analysis rule to obtain the down-adjustability attribute of the initial media encoding parameter of the second media object.

Specifically, based on the above, the second parameter analysis rule may be adopted to analyze whether the initial media encoding parameter of the second media object can be adjusted down. If the initial media encoding parameter of the second media object conforms to each criterion included in the second parameter analysis rule, then it may be considered that the initial media encoding parameter of the second media object conforms to the second parameter analysis rule, and it may be considered that, after analysis based on the second parameter analysis rule, the second media object is determined to be capable of being subject to down adjustment of the media encoding parameter. Here, an analysis result obtained by adopting the second parameter analysis rule for analysis may be determined as an analysis result of the down-adjustability attribute of the initial media encoding parameter. The down-adjustability attribute is to include an adjustable attribute and a non-adjustable attribute. The adjustable attribute of the down-adjustability attribute may indicate that the initial media encoding parameter of the second media object conforms to the second parameter analysis rule, the initial media encoding parameter of the second media object satisfies a parameter adjustment condition, and the initial media encoding parameter of the second media object can be adjusted down. The non-adjustable attribute of the down-adjustability attribute may indicate that the initial media encoding parameter of the second media object does not conform to the second parameter analysis rule, the initial media encoding parameter of the second media object does not satisfy the parameter adjustment condition, and the initial media encoding parameter of the second media object cannot be adjusted down.

In one embodiment, one exemplary embodiment for analyzing and detecting the initial media encoding parameter of the second media object by adopting the second parameter analysis rule to obtain the down-adjustability attribute of the initial media encoding parameter of the second media object may include but is not limited to the following: for ease of distinction, the initial media encoding parameter of the second media object may be first determined as a second initial encoding parameter, and a media quality of the second media object at the second initial encoding parameter may be determined as a second media quality. Further, according to the second parameter analysis rule, the second media quality may be compared with a quality upper limit threshold, to determine whether the second media quality is actually higher than the quality upper limit threshold (i.e., whether the second media quality actually satisfies the preset quality condition). A comparison result may be obtained through comparison (which may be referred to as a second comparison result here, and the second comparison result is to include a result that the second media quality is higher than the quality upper limit threshold, and a result that the second media quality is lower than the quality upper limit threshold). Further, the above K configured media encoding parameters may be acquired. Based on the second initial encoding parameter, the K configured media encoding parameters may be traversed, to query whether there is a configured media encoding parameter whose parameter level is lower than a parameter level of the second initial encoding parameter in the K configured media encoding parameters. Since the initial media encoding parameter of the second media object needs to be adjusted down to balance an average media encoding parameter of the media object sequence during preloading, if there is no configured media encoding parameter whose parameter level is lower than the parameter level of the second initial encoding parameter in the K configured media encoding parameters, then the second initial encoding parameter cannot be adjusted down, because it is already the smallest value of the media encoding parameter. If there are configured media encoding parameters with lower parameter levels in the K configured media encoding parameters, the present disclosure may use them as candidate down-adjusted media encoding parameters, and select, from the candidate down-adjusted media encoding parameters, the largest one as a down-adjusted media encoding parameter for this adjustment (i.e., a parameter level of the down-adjusted media encoding parameter is only one level lower than a parameter level of the second initial encoding parameter). Then, the down-adjustability attribute of the initial media encoding parameter of the second media object may be jointly analyzed based on a traversal result in combination with the above second comparison result. Specifically, if the second comparison result indicates that the second media quality is greater than the quality upper limit threshold, and the traversal result indicates that there are configured media encoding parameters with parameter levels lower than the second initial encoding parameter in the K configured media encoding parameters, then it may be considered that the second media quality indeed does not satisfy the preset quality condition, and meanwhile there are configured media encoding parameters with lower parameter levels in the K configured media encoding parameters. In this case, the media encoding parameter of the second media object can be adjusted down, and the down-adjustability attribute of the initial media encoding parameter of the second media object may be determined as an adjustable attribute. Conversely, if the second comparison result indicates that the second media quality is less than the quality upper limit threshold, or the traversal result indicates that there are no configured media encoding parameters with parameter levels lower than the second initial encoding parameter in the K configured media encoding parameters, then it may be considered that the second media quality satisfies the preset quality condition, or there are no configured media encoding parameters with lower parameter levels. In either case, the initial media encoding parameter of the second media object cannot be adjusted down, and the down-adjustability attribute of the initial media encoding parameter of the second media object may be determined as a non-adjustable attribute. In general, for the second media object, a parameter adjustment condition of the initial media encoding parameter thereof means that the parameter is to satisfy a condition of the second parameter analysis rule. If the parameter does not satisfy the second parameter analysis rule, then the parameter does not satisfy the parameter adjustment condition either.

In summary, the first parameter analysis rule at least includes three criteria: 1) a media quality of a media object at a current media encoding parameter (such as a first initial encoding parameter) is to be lower than a quality lower limit threshold (for example, 70 points); 2) in the K configured media encoding parameters, there is a configured media encoding parameter whose parameter level is higher than a parameter level of the current media encoding parameter; and 3) a difference between the adjusted-up media encoding parameter and the predicted network speed cannot be higher than a difference threshold. If the above three criteria are satisfied, it may be considered that the media object conforms to the first parameter analysis rule. The second parameter analysis rule at least includes two criteria: 1) a media quality of a media object at a current media encoding parameter (such as a second initial encoding parameter) is to be higher than a quality upper limit threshold (for example, 90 points); and 2) in the K configured media encoding parameters, there is a configured media encoding parameter whose parameter level is lower than a parameter level of the current media encoding parameter. If the above two criteria are satisfied, it may be considered that the media object conforms to the second parameter analysis rule.

Operation S404: Determine whether the up-adjustability attribute of the initial media encoding parameter of the first media object and the down-adjustability attribute of the initial media encoding parameter of the second media object are both adjustable attributes.

Specifically, after determining the up-adjustability attribute of the initial media encoding parameter of the first media object and the down-adjustability attribute of the initial media encoding parameter of the second media object, it may be determined whether both are adjustable attributes. If both are adjustable attributes, subsequent operation S405 may be performed. If either or both are non-adjustable attributes, then subsequent operation S406 may be performed.

Operation S405: Determine that both the first analysis result and the second analysis result are condition-satisfied results if both the up-adjustability attribute of the initial media encoding parameter of the first media object and the down-adjustability attribute of the initial media encoding parameter of the second media object are adjustable attributes.

Specifically, if the up-adjustability attribute of the initial media encoding parameter of the first media object and the down-adjustability attribute of the initial media encoding parameter of the second media object are both adjustable attributes, then it may be determined that the initial media encoding parameters of the first media object and the second media object both conform to corresponding parameter analysis rules. In this case, the first analysis result of the first media object and the second analysis result of the second media object may both be determined as condition-satisfied results.

Operation S406: Determine that both the first analysis result and the second analysis result are condition-unsatisfied results if either the up-adjustability attribute of the initial media encoding parameter of the first media object or the down-adjustability attribute of the initial media encoding parameter of the second media object is a non-adjustable attribute.

Specifically, if the up-adjustability attribute of the initial media encoding parameter of the first media object or the down-adjustability attribute of the initial media encoding parameter of the second media object is a non-adjustable attribute, then it may be determined that the initial media encoding parameter of the first media object does not conform to the corresponding parameter analysis rule, or the initial media encoding parameter of the second media object does not conform to the corresponding parameter analysis rule. In this case, the first analysis result of the first media object and the second analysis result of the second media object may both be determined as condition-unsatisfied results. That is to say, even if the initial media encoding parameter of the first media object conforms to the first parameter analysis rule, since the initial media encoding parameter of the second media object does not conform to the second parameter analysis rule and cannot be adjusted down, the initial media encoding parameter of the first media object cannot be adjusted up either, and a parameter analysis result thereof is to be a condition-unsatisfied result.

In summary, it can be seen that, in the present disclosure, a parameter adjustment condition refers to a condition that an initial media encoding parameter is to conform to a corresponding parameter analysis rule (such as the first parameter analysis rule and the second parameter analysis rule). If the initial media encoding parameter does not conform to the corresponding parameter analysis rule, the parameter adjustment condition is not satisfied.

The embodiment of the present disclosure can allocate, under the constraint of the predicted network speed, the media encoding parameter adapted to the media content of each media object itself to different media objects, and can dynamically optimize, under the constraint of the predicted network speed, the media encoding parameter of the media object that does not satisfy the preset quality condition in the media object sequence, so that the media encoding parameter can satisfy the preset quality condition, thereby improving or enhancing the overall playback quality of the media object sequence. Moreover, in a process of dynamically adjusting the media encoding parameter of the media object that does not satisfy the preset quality condition in the media object sequence, adjustment is not performed in a one-size-fits-all way. Instead, analysis and detection are performed in advance, and adjustment is performed only when it is determined that simultaneous dynamic optimization can indeed be performed. In this way, balance and rationality of parameter adjustment can be improved, further enhancing the overall playback quality of the media object sequence, i.e., the embodiment of the present disclosure can combine the media quality of the media object and dynamically optimize the media encoding parameter of the media object under the constraint of the predicted network speed. Compared with a one-size-fits-all media encoding parameter adjustment, the embodiment of the present disclosure can improve the overall playback quality of the media object sequence while reducing the situation of playback freeze during the playing process.

From the above, the target media object includes a first media object and a second media object. Therefore, in the embodiment corresponding to FIG. 3 above, when adjusting the initial media encoding parameter of the target media object, the initial media encoding parameter of the first media object (a first initial encoding parameter) needs to be adjusted up, and meanwhile the initial media encoding parameter of the second media object (a second initial encoding parameter) needs to be adjusted down. A specific process may include: determining a configured media encoding parameter whose parameter level is higher than the above first initial encoding parameter in the K configured media encoding parameters as an up-adjusted media encoding parameter; determining a configured media encoding parameter whose parameter level is lower than the above second initial encoding parameter in the K configured media encoding parameters as a first down-adjusted media encoding parameter; and then adjusting the initial media encoding parameter of the first media object to the up-adjusted media encoding parameter, and adjusting the initial media encoding parameter of the second media object to the first down-adjusted media encoding parameter.

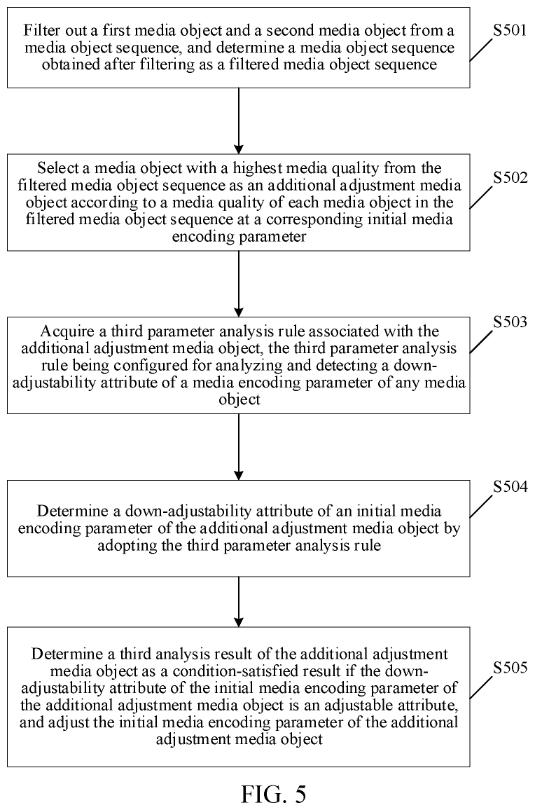

In a feasible embodiment, after correspondingly adjusting the initial media encoding parameters of the above first media object and second media object, the present disclosure may consider whether to also adjust down a media encoding parameter of a media object with a second highest media quality in the media object sequence (i.e., a media object with a second highest media quality at a corresponding initial media encoding parameter) in the media object sequence. The present disclosure may use the media object with the second highest media quality as an additional media object for parameter adjustment (referred to as an additional adjustment media object), and configure and set a corresponding parameter analysis rule (a third parameter analysis rule) for the additional adjustment media object. According to the third parameter analysis rule, the additional adjustment media object may be analyzed to determine whether the additional adjustment media object conforms to the rule. In a case that the additional adjustment media object conforms to the rule, it may be considered that an initial media encoding parameter thereof satisfies a parameter adjustment condition, and the initial media encoding parameter thereof may be appropriately adjusted down. For ease of understanding a specific process thereof, refer to FIG. 5. FIG. 5 is a schematic flowchart of performing parameter adjustment on an additional adjustment media object according to an embodiment of the present disclosure. As shown in FIG. 5, the process may at least include the following operations S501 to S505:

Operation S501: Filter out the first media object and the second media object from the media object sequence, and determine a media object sequence obtained after filtering as a filtered media object sequence.

Specifically, for ease of better understanding the additional adjustment media object, the first media object and the second media object in the media object sequence may be first filtered out here, so as to select the additional adjustment media object from a media object sequence obtained after filtering (referred to as a filtered media object sequence).

Operation S502: Select a media object with a highest media quality from the filtered media object sequence as an additional adjustment media object according to the media quality of each media object in the filtered media object sequence at the corresponding initial media encoding parameter.

Specifically, a media quality of each media object included in the filtered media object sequence at a corresponding initial media encoding parameter may be acquired, and a media object with a highest media quality in these media qualities is the additional adjustment media object.

Operation S503: Acquire a third parameter analysis rule associated with the additional adjustment media object, the third parameter analysis rule being configured for analyzing and detecting a down-adjustability attribute of a media encoding parameter of any media object.

Specifically, the third parameter analysis rule in the present disclosure at least includes three criteria: 1) a media quality of a media object at a current media encoding parameter (such as an initial media encoding parameter of an additional adjustment media object) is to be higher than a quality upper limit threshold (for example, 90 points); 2) in the K configured media encoding parameters, there is a configured media encoding parameter whose parameter level is lower than a parameter level of the current media encoding parameter; and 3) after down adjustment, a parameter fluctuation caused by adjusting down the initial media encoding parameter of the additional adjustment media object is smaller than a parameter fluctuation caused by adjusting down only the initial media encoding parameter of a second media object (such as a second initial encoding parameter). By adopting the third parameter analysis rule, whether a media encoding parameter of any media object has down-adjustability can be analyzed and detected.

For ease of understanding the third criterion in the third parameter analysis rule (i.e., criterion 3), refer to formula (3). Formula (3) can express a requirement of the criterion 3, as shown in formula (3):

$$abs ( ( B {r}_{k}^{q b 1} - B {r}_{k - 1}^{q b 1} ) + ( B {r}_{k}^{q b 2} - B {r}_{k - 1}^{q b 2} ) - ( B {r}_{k + 1}^{q w 0} - B {r}_{k}^{q w 0} ) ) < abs ( ( B {r}_{k}^{q b 1} - B {r}_{k - 1}^{q b 1} ) - ( B {r}_{k + 1}^{q w 0} - B {r}_{k}^{q w 0} ) ) \qquad Formula ( 3 )$$

where qb1 may be configured for representing a media object with a highest media quality in a media object sequence (such as the above second media object); qb2 may be configured for representing a media object with a second highest media quality in the media object sequence (such as the above additional adjustment media object); qw0 may be configured for representing a media object with a lowest media quality in the media object sequence (such as the above first media object);

$$B {r}_{k - 1}^{q b 1}$$

may be configured tor representing an adjusted-down media encoding parameter of qb1 (such as the above first down-adjusted media encoding parameter);

$$B {r}_{k}^{q b 1}$$

may be configured tor representing an initial media encoding parameter of qb1;

$$B {r}_{k - 1}^{q b 2}$$

may be configured for representing an adjusted-down media encoding parameter of qb2 (such as a second down-adjusted media encoding parameter mentioned later);

$$B {r}_{k}^{q b 2}$$

may be configured tor representing an initial media encoding parameter of qb2 (such as a third initial encoding parameter mentioned later);

$$B {r}_{k + 1}^{q w 0}$$

may be configured for representing an adjusted-up media encoding parameter of qw0 (such as the above up-adjusted media encoding parameter);

$$B {r}_{k}^{q w 0}$$

may be configured for representing an initial media encoding parameter of qw0 (such as the above first initial encoding parameter); and abs( ) may be configured for representing a summation function. It can be known from the above formula (3) that an absolute value of a difference between a sum of media encoding parameters reduced by adjusting down the initial media encoding parameter of the additional adjustment media object together with adjusting down the parameter of the second media object, and a media encoding parameter increased by adjusting the first media object, is to be smaller than an absolute value of a difference between a media encoding parameter reduced by adjusting down the media encoding parameter of the second media object alone, and the media encoding parameter increased by adjusting the first media object.

Operation S504: Analyze and detect the down-adjustability attribute of the initial media encoding parameter of the additional adjustment media object by adopting the third parameter analysis rule to obtain the down-adjustability attribute of the initial media encoding parameter of the additional adjustment media object.

In one embodiment, one exemplary embodiment for analyzing and detecting the down-adjustability attribute of the initial media encoding parameter of the additional adjustment media object by adopting the third parameter analysis rule to obtain the down-adjustability attribute of the initial media encoding parameter of the additional adjustment media object may include but is not limited to the following: for ease of distinction, the initial media encoding parameter of the additional adjustment media object may be first determined as a third initial encoding parameter, and a media quality of the additional adjustment media object at the third initial encoding parameter may be determined as a third media quality. Further, according to the third parameter analysis rule, the third media quality may be compared with a quality upper limit threshold, to determine whether the third media quality is actually higher than the quality upper limit threshold (i.e., whether the third media quality actually satisfies the preset quality condition). A comparison result may be obtained through comparison (which may be referred to as a third comparison result here, and the third comparison result is to include a result that the third media quality is higher than the quality upper limit threshold, and a result that the third media quality is lower than the quality upper limit threshold). Further, the K configured media encoding parameters may be traversed, to query whether there is a configured media encoding parameter whose parameter level is lower than a parameter level of the third initial encoding parameter in the K configured media encoding parameters. Since the initial media encoding parameter of the additional adjustment media object needs to be adjusted down to balance an average media encoding parameter of a media object sequence during preloading, if there is no configured media encoding parameter whose parameter level is lower than the parameter level of the third initial encoding parameter in the K configured media encoding parameters, then the third initial encoding parameter cannot be adjusted down, because it is already the smallest value of the media encoding parameter. If there are configured media encoding parameters with lower parameter levels in the K configured media encoding parameters, the present disclosure may use them as candidate down-adjusted media encoding parameters, and select, from the candidate down-adjusted media encoding parameters, the largest one as a second down-adjusted media encoding parameter for this adjustment (i.e., a parameter level of the down-adjusted media encoding parameter is only one level lower than a parameter level of the third initial encoding parameter). Finally, according to criterion 3 indicated by the above formula (3), the down-adjustability attribute of the initial media encoding parameter of the additional adjustment media object may be analyzed based on the first down-adjusted media encoding parameter, the second down-adjusted media encoding parameter, and the up-adjusted media encoding parameter.

One exemplary embodiment thereof may include but is not limited to the following: a first difference between a second initial encoding parameter and a first down-adjusted media encoding parameter, a second difference between a third initial encoding parameter and a second down-adjusted media encoding parameter, and a third difference between an up-adjusted media encoding parameter and a first initial encoding parameter may be determined; a difference sum of the first difference and the second difference may be determined; a difference between the difference sum and the third difference may be determined as a first fluctuation value, and a difference between the first difference and the third difference may be determined as a second fluctuation value; if the first fluctuation value is greater than the second fluctuation value, then it may be considered that adjusting down the initial media encoding parameter of the additional adjustment media object brings greater overall parameter fluctuation (such as bit rate fluctuation), and the down-adjustability attribute of the initial media encoding parameter of the additional adjustment media object may be determined as a non-adjustable attribute; and if the first fluctuation value is less than the second fluctuation value, then it may be considered that adjusting down the initial media encoding parameter of the additional adjustment media object reduces overall parameter fluctuation, and the down-adjustability attribute of the initial media encoding parameter of the additional adjustment media object may be determined as an adjustable attribute.

Operation S505: Determine a third analysis result of the additional adjustment media object as a condition-satisfied result if the down-adjustability attribute of the initial media encoding parameter of the additional adjustment media object is an adjustable attribute, and adjust the initial media encoding parameter of the additional adjustment media object.

Specifically, if the down-adjustability attribute of the initial media encoding parameter of the additional adjustment media object is an adjustable attribute, then a third analysis result of the additional adjustment media object may be determined as a condition-satisfied result, and the initial media encoding parameter of the additional adjustment media object may be adjusted. For example, the initial media encoding parameter of the additional adjustment media object may be adjusted down to the above second down-adjusted media encoding parameter. In general, for the additional adjustment media object, a parameter adjustment condition of the initial media encoding parameter thereof means that the parameter is to satisfy a condition of the third parameter analysis rule. If the parameter does not satisfy the third parameter analysis rule, then the parameter does not satisfy the parameter adjustment condition either, and a down-adjustability attribute thereof is to be a non-adjustable attribute.

In summary, it can be seen that the embodiment of the present disclosure can allocate, under the constraint of the predicted network speed, the media encoding parameter adapted to the media content of the media object itself for the media object, and can adaptively dynamically optimize, under the constraint of the predicted network speed and in combination with the media quality of the media object, the media encoding parameter of the target media object that does not satisfy the preset quality condition, so that the target media object can satisfy the preset quality condition while not causing relatively great fluctuation and change of the media encoding parameter, thereby improving or enhancing the overall playback quality of the media object sequence. Based on this, in order to reduce parameter fluctuation caused by adjusting the media encoding parameter, the present disclosure may additionally determine a media object with a second highest media quality, to determine whether it is necessary to adjust down a media encoding parameter thereof to smooth parameter fluctuation. In this way, while improving the overall playback quality of the media object sequence, fluctuation and change of the media encoding parameter can be further reduced.

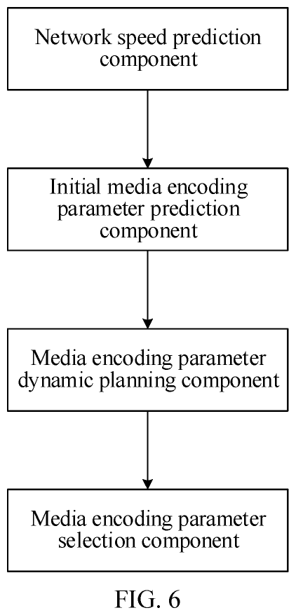

Further, for ease of understanding, refer to FIG. 6. FIG. 6 is a schematic diagram of a system logical architecture according to an embodiment of the present disclosure. As shown in FIG. 6, the system logical architecture at least needs to include the following components:

### 1. Network Speed Prediction Component:

The network speed prediction component may be configured to predict a network speed corresponding to a media object sequence to be played (i.e., a network speed during playing of the media object sequence, which may be referred to as a predicted network speed corresponding to the media object sequence). Specifically, the network speed may be obtained by calculation based on historical network speeds at different time points within a historical time period.

### 2. Initial Media Encoding Parameter Prediction Component:

The initial media encoding parameter prediction component may be configured to predict, under a constraint of a predicted network speed and from K configured media encoding parameters, an initial media encoding parameter adapted to a media content of each media object itself for each media object. Each initial media encoding parameter does not exceed the predicted network speed. For example, for a media object with relatively simple media content, a relatively high media quality can be obtained by adopting a relatively small media encoding parameter. In this case, exemplary configured media encoding parameters of the media object may be all of the K configured media encoding parameters. Then, for the media object, the largest configured media encoding parameter in all configured media encoding parameters lower than the predicted network speed may be selected as the initial media encoding parameter thereof. For a media object with relatively complex media content, a relatively large media encoding parameter needs to be adopted to ensure the media quality. In this case, exemplary configured media encoding parameters of the media object may be three configured media encoding parameters with relatively high levels. All configured media encoding parameters lower than the predicted network speed may be determined from the three configured media encoding parameters, and then the largest configured media encoding parameter is selected therefrom as the initial media encoding parameter thereof.

### 3. Media Encoding Parameter Dynamic Planning Component:

The media encoding parameter dynamic planning component may be configured to acquire a media quality of each media object at a corresponding initial media encoding parameter, select a target media object that does not satisfy a preset quality condition, and then analyze, according to a corresponding parameter analysis rule, whether an initial media encoding parameter of the target media object can be adjusted. In addition, the media encoding parameter dynamic planning component may also be configured to acquire an additional adjustment media object with a second highest media quality, and analyze, according to a corresponding parameter analysis rule, whether an initial media encoding parameter of the additional adjustment media object can be adjusted.

### 4. Media Encoding Parameter Selection Component:

The media encoding parameter selection component may be configured to determine, based on an analysis result of the media encoding parameter dynamic planning component, whether to adjust the initial media encoding parameters of the target media object and the additional adjustment media object, and when it is determined that adjustment is needed, perform corresponding adjustment (such as up adjustment or down adjustment) on the initial media encoding parameters.

For implementation functions of the above 4 components, a reference may be made to corresponding descriptions in the foregoing embodiments, and details will not be described here again. Beneficial effects brought by the above components will also not be described here again.

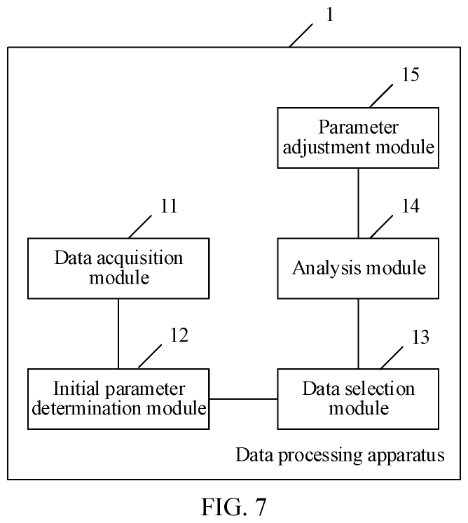

Further, refer to FIG. 7. FIG. 7 is a schematic structural diagram of a data processing apparatus according to an embodiment of the present disclosure. The data processing apparatus may be a computer program (including program codes) running in a computer device. For example, the data processing apparatus is application software. The data processing apparatus may be configured to perform the method shown in FIG. 3. As shown in FIG. 7, the data processing apparatus 1 may include a data acquisition module 11, an initial parameter determination module 12, a data selection module 13, an analysis module 14, and a parameter adjustment module 15.

The data acquisition module 11 is configured to acquire a media object sequence to be played, the media object sequence being composed of N media objects, N being a positive integer.

The initial parameter determination module 12 is configured to determine an initial media encoding parameter corresponding to each media object based on a predicted network speed corresponding to the media object sequence.

The data selection module 13 is configured to select a target media object whose media quality does not satisfy a preset quality condition from the media object sequence based on a media quality of each media object at the corresponding initial media encoding parameter, satisfying the preset quality condition referring to a media quality being not higher than a quality upper limit threshold or not lower than a quality lower limit threshold.

The analysis module 14 is configured to analyze the initial media encoding parameter of the target media object based on the predicted network speed to obtain an analysis result, the analysis result indicating whether the initial media encoding parameter of the target media object satisfies a parameter adjustment condition.

The parameter adjustment module 15 is configured to adjust the initial media encoding parameter of the target media object in response to the analysis result indicating that the initial media encoding parameter of the target media object satisfies the parameter adjustment condition, a media quality of the target media object at an adjusted media encoding parameter satisfying the preset quality condition.

For the implementations of the data acquisition module 11, the initial parameter determination module 12, the data selection module 13, the analysis module 14, and the parameter adjustment module 15, a reference may be made to the description of operations S101 to S105 in the embodiment corresponding to FIG. 3 above, and details will not be described here again.

In an embodiment, an exemplary implementation in which the initial parameter determination module 12 determines an initial media encoding parameter corresponding to each media object based on a predicted network speed corresponding to the media object sequence includes:
acquiring an average network speed of a historical time period, and determining the average network speed as the predicted network speed of the media object sequence, the historical time period being earlier than a time when the media object sequence is played;
acquiring K configured media encoding parameters, parameter levels to which the K configured media encoding parameters belong being different from each other, K being a positive integer (e.g., K being greater than 1); and
performing parameter adaptation analysis on each media object based on the predicted network speed to select from the K configured media encoding parameters the initial media encoding parameter of each media object.

In an embodiment, an exemplary implementation in which the initial parameter determination module 12 acquires an average network speed of a historical time period includes:
sampling T time points from the historical time period according to a time sampling rule, T being a positive integer;
acquiring historical network speeds respectively corresponding to each of the T time points to obtain T historical network speeds;
determining an average value of the T historical network speeds; and
determining the average value of the T historical network speeds as the average network speed of the historical time period.

In an embodiment, an exemplary implementation in which the initial parameter determination module 12 performs parameter adaptation analysis on each media object based on the predicted network speed to select from the K configured media encoding parameters the initial media encoding parameter corresponding to each media object includes:
determining any media object in the media object sequence as an analysis media object;
acquiring a media content of the analysis media object;
invoking a parameter prediction model based on the media content of the analysis media object, the parameter prediction model being deployed with the K configured media encoding parameters;
performing comprehensive analysis on the media content of the analysis media object and the predicted network speed through the parameter prediction model to output a predicted media encoding parameter adapted to the analysis media object, the predicted media encoding parameter being less than the predicted network speed; and
determining the predicted media encoding parameter of the analysis media object as the initial media encoding parameter of the analysis media object.

In an embodiment, the target media object whose media quality does not satisfy a preset quality condition includes a first media object and a second media object, the first media object referring to a media object with a lowest media quality in the media object sequence, and the second media object referring to a media object with a highest media quality in the media object sequence; and the analysis result includes a first analysis result of the first media object and a second analysis result of the second media object; and
an exemplary implementation in which the analysis module analyzes the initial media encoding parameter of the target media object based on the predicted network speed to obtain an analysis result includes:
acquiring a first parameter analysis rule associated with the first media object and a second parameter analysis rule associated with the second media object, the first parameter analysis rule being used in conjunction with the predicted network speed for jointly analyzing and detecting an up-adjustability attribute of a media encoding parameter of any media object, and the second parameter analysis rule being configured for analyzing and detecting a down-adjustability attribute of a media encoding parameter of any media object;
analyzing and detecting the up-adjustability attribute of the initial media encoding parameter of the first media object by adopting the first parameter analysis rule and the predicted network speed to obtain the up-adjustability attribute of the initial media encoding parameter of the first media object;
analyzing and detecting the down-adjustability attribute of the initial media encoding parameter of the second media object by adopting the second parameter analysis rule to obtain the down-adjustability attribute of the initial media encoding parameter of the second media object;
determining that both the first analysis result and the second analysis result are condition-satisfied results if both the up-adjustability attribute of the initial media encoding parameter of the first media object and the down-adjustability attribute of the initial media encoding parameter of the second media object are adjustable attributes; and
determining that both the first analysis result and the second analysis result are condition-unsatisfied results if either the up-adjustability attribute of the initial media encoding parameter of the first media object or the down-adjustability attribute of the initial media encoding parameter of the second media object is a non-adjustable attribute.

In an embodiment, an exemplary implementation in which the analysis module analyzes and detects the up-adjustability attribute of the initial media encoding parameter of the first media object by adopting the first parameter analysis rule and the predicted network speed to obtain the up-adjustability attribute of the initial media encoding parameter of the first media object includes:
determining the initial media encoding parameter of the first media object as a first initial encoding parameter, and determining a media quality of the first media object at the first initial encoding parameter as a first media quality;
comparing the first media quality with the quality lower limit threshold according to the first parameter analysis rule to obtain a first comparison result;
acquiring K configured media encoding parameters, parameter levels to which any two configured media encoding parameters in the K configured media encoding parameters belong being different from each other, K being a positive integer;
acquiring a configured media encoding parameter whose parameter level is higher than a parameter level of the first initial encoding parameter from the K configured media encoding parameters, and determining the configured media encoding parameter whose parameter level is higher than the parameter level of the first initial encoding parameter in the K configured media encoding parameters as an up-adjusted media encoding parameter; and
determining the up-adjustability attribute of the initial media encoding parameter of the first media object based on a difference between the predicted network speed and the up-adjusted media encoding parameter, and the first comparison result.

In an embodiment, an exemplary implementation in which the analysis module determines the up-adjustability attribute of the initial media encoding parameter of the first media object based on a difference between the predicted network speed and the up-adjusted media encoding parameter, and the first comparison result includes:
determining the up-adjustability attribute of the initial media encoding parameter of the first media object as an adjustable attribute if the difference between the predicted network speed and the up-adjusted media encoding parameter is less than a difference threshold, and the first comparison result indicates that the first media quality is less than the quality lower limit threshold; and
determining the up-adjustability attribute of the initial media encoding parameter of the first media object as a non-adjustable attribute if the difference between the predicted network speed and the up-adjusted media encoding parameter is greater than the difference threshold, or the first comparison result indicates that the first media quality is greater than the quality lower limit threshold.

In an embodiment, an exemplary implementation in which the analysis module analyzes and detects the down-adjustability attribute of the initial media encoding parameter of the second media object by adopting the second parameter analysis rule to obtain the down-adjustability attribute of the initial media encoding parameter of the second media object includes:
determining the initial media encoding parameter of the second media object as a second initial encoding parameter, and determining a media quality of the second media object at the second initial encoding parameter as a second media quality;
comparing the second media quality with the quality upper limit threshold according to the second parameter analysis rule to obtain a second comparison result;
acquiring K configured media encoding parameters, parameter levels to which any two configured media encoding parameters in the K configured media encoding parameters belong being different from each other, K being a positive integer;
traversing the K configured media encoding parameters based on the second initial encoding parameter to obtain a traversal result;
determining the down-adjustability attribute of the initial media encoding parameter of the second media object as an adjustable attribute if the second comparison result indicates that the second media quality is greater than the quality upper limit threshold, and the traversal result indicates that there is a configured media encoding parameter whose parameter level is lower than a parameter level of the second initial encoding parameter in the K configured media encoding parameters; and
determining the down-adjustability attribute of the initial media encoding parameter of the second media object as a non-adjustable attribute if the second comparison result indicates that the second media quality is less than the quality upper limit threshold, or the traversal result indicates that there is no configured media encoding parameter whose parameter level is lower than the parameter level of the second initial encoding parameter in the K configured media encoding parameters.

In an embodiment, an exemplary implementation in which the parameter adjustment module adjusts the initial media encoding parameter of the target media object includes:
acquiring K configured media encoding parameters, parameter levels to which any two configured media encoding parameters in the K configured media encoding parameters belong being different from each other, K being a positive integer;
determining a configured media encoding parameter whose parameter level is higher than a parameter level of the first initial encoding parameter in the K configured media encoding parameters as an up-adjusted media encoding parameter, the first initial encoding parameter referring to the initial media encoding parameter of the first media object;
determining a configured media encoding parameter whose parameter level is lower than a parameter level of the second initial encoding parameter in the K configured media encoding parameters as a first down-adjusted media encoding parameter, the second initial encoding parameter referring to the initial media encoding parameter of the second media object; and
adjusting the initial media encoding parameter of the first media object to the up-adjusted media encoding parameter, and adjusting the initial media encoding parameter of the second media object to the first down-adjusted media encoding parameter.

In an embodiment, after the parameter adjustment module adjusts the initial media encoding parameter of the first media object to the up-adjusted media encoding parameter, and adjusts the initial media encoding parameter of the second media object to the first down-adjusted media encoding parameter, the parameter adjustment module is further configured to filter out the first media object and the second media object from the media object sequence, and determine a media object sequence obtained after filtering as a filtered media object sequence.

The parameter adjustment module is further configured to select a media object with a highest media quality from the filtered media object sequence as an additional adjustment media object according to the media quality of each media object in the filtered media object sequence at the corresponding initial media encoding parameter.

The parameter adjustment module is further configured to acquire a third parameter analysis rule associated with the additional adjustment media object, the third parameter analysis rule being configured for analyzing and detecting a down-adjustability attribute of a media encoding parameter of any media object.

The parameter adjustment module is further configured to analyze and detect the down-adjustability attribute of the initial media encoding parameter of the additional adjustment media object by adopting the third parameter analysis rule to obtain the down-adjustability attribute of the initial media encoding parameter of the additional adjustment media object.

The parameter adjustment module is further configured to determine a third analysis result of the additional adjustment media object as a condition-satisfied result if the down-adjustability attribute of the initial media encoding parameter of the additional adjustment media object is an adjustable attribute, and adjust the initial media encoding parameter of the additional adjustment media object.

In an embodiment, an exemplary implementation in which the parameter adjustment module analyzes and detects the down-adjustability attribute of the initial media encoding parameter of the additional adjustment media object by adopting the third parameter analysis rule to obtain the down-adjustability attribute of the initial media encoding parameter of the additional adjustment media object includes:
determining the initial media encoding parameter of the additional adjustment media object as a third initial encoding parameter, and determining a media quality of the additional adjustment media object at the third initial encoding parameter as a third media quality;
comparing the third media quality with the quality upper limit threshold according to the third parameter analysis rule to obtain a third comparison result;
acquiring a configured media encoding parameter whose parameter level is lower than a parameter level of the third initial encoding parameter from the K configured media encoding parameters, and determining the configured media encoding parameter whose parameter level is lower than the parameter level of the third initial encoding parameter in the K configured media encoding parameters as a second down-adjusted media encoding parameter; and
analyzing the down-adjustability attribute of the initial media encoding parameter of the additional adjustment media object based on the first down-adjusted media encoding parameter, the second down-adjusted media encoding parameter, and the up-adjusted media encoding parameter.

In an embodiment, an exemplary implementation in which the parameter adjustment module analyzes the down-adjustability attribute of the initial media encoding parameter of the additional adjustment media object based on the first down-adjusted media encoding parameter, the second down-adjusted media encoding parameter, and the up-adjusted media encoding parameter includes:
determining a first difference between the second initial encoding parameter and the first down-adjusted media encoding parameter, a second difference between the third initial encoding parameter and the second down-adjusted media encoding parameter, and a third difference between the up-adjusted media encoding parameter and the first initial encoding parameter;
determining a difference sum of the first difference and the second difference;
determining a difference between the difference sum and the third difference as a first fluctuation value;
determining a difference between the first difference and the third difference as a second fluctuation value;
determining the down-adjustability attribute of the initial media encoding parameter of the additional adjustment media object as a non-adjustable attribute if the first fluctuation value is greater than the second fluctuation value; and
determining the down-adjustability attribute of the initial media encoding parameter of the additional adjustment media object as an adjustable attribute if the first fluctuation value is less than the second fluctuation value.

The embodiment of the present disclosure can allocate, under the constraint of the predicted network speed, the media encoding parameter adapted to the media content of the media object itself for different media objects, and can adaptively dynamically optimize, under the constraint of the predicted network speed and in combination with the media quality of the media object, the media encoding parameters of different media objects, so that the target media object can satisfy the preset quality condition while not causing relatively great fluctuation and change of the media encoding parameter, thereby improving or enhancing the overall playback quality of the media object sequence.

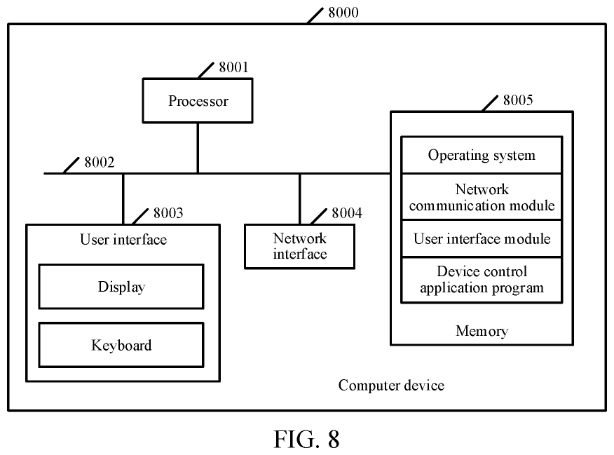

Further, refer to FIG. 8. FIG. 8 is a schematic structural diagram of a computer device according to an embodiment of the present disclosure. As shown in FIG. 8, the computer device 8000 may include a processor 8001, a network interface 8004, and a memory 8005. In addition, the computer device 8000 further includes a user interface 8003 and at least one communication bus 8002. The communications bus 8002 is configured to implement connection and communication between the components. The user interface 8003 may include a display and a keyboard. In some embodiments, the user interface 8003 may further include a standard wired interface and a standard wireless interface. In some embodiments, the network interface 8004 may include a standard wired interface and wireless interface (such as WI-FI interface). The memory 8005 may be a high-speed RAM memory, or a non-volatile memory, for example, at least one magnetic disk memory. In some embodiments, the memory 8005 may be at least one storage apparatus located remotely from the foregoing processor 8001. Referring to FIG. 8, the memory 8005 used as a computer storage medium may include an operating system, a network communications module, a user interface module, and a device control application program.

In the computer device 8000 shown in FIG. 8, the network interface 8004 may provide a network communication function; the user interface 8003 is mainly an interface configured to provide input for a user; and the processor 8001 may be configured to invoke the device control application program stored in the memory 8005 to implement:
acquiring a media object sequence to be played, the media object sequence being composed of N media objects, N being a positive integer;
determining an initial media encoding parameter corresponding to each media object based on a predicted network speed corresponding to the media object sequence;
selecting a target media object whose media quality does not satisfy a preset quality condition from the media object sequence based on a media quality of each media object at the corresponding initial media encoding parameter, satisfying the preset quality condition referring to a media quality being not higher than a quality upper limit threshold or not lower than a quality lower limit threshold;
analyzing the initial media encoding parameter of the target media object based on the predicted network speed to obtain an analysis result, the analysis result indicating whether the initial media encoding parameter of the target media object satisfies a parameter adjustment condition; and
adjusting the initial media encoding parameter of the target media object in response to the analysis result indicating that the initial media encoding parameter of the target media object satisfies the parameter adjustment condition, a media quality of the target media object at an adjusted media encoding parameter satisfying the preset quality condition.

The computer device 8000 described in the embodiment of the present disclosure can implement the descriptions of the data processing method in the foregoing embodiments corresponding to FIG. 3 to FIG. 5, and can also implement the descriptions of the data processing apparatus 1 in the foregoing embodiment corresponding to FIG. 7, which will not be repeated here. In addition, the description of beneficial effects of the same method will not be repeated here.

In addition, an embodiment of the present disclosure further provides a computer-readable storage medium, having a computer program, executed by the computer device 8000 for data processing mentioned above, stored therein, the computer program including program instructions. When executing the program instructions, the processor can perform the descriptions of the data processing method in the foregoing embodiments corresponding to FIG. 3 to FIG. 5. Therefore, details are not described here again. In addition, the description of beneficial effects of the same method will not be repeated here. For technical details that are not disclosed in the computer storage medium embodiment of the present disclosure, refer to the description of the method embodiments of the present disclosure.

The computer-readable storage medium may be the data processing apparatus according to any one of the embodiments or an internal storage unit of the computer device, such as a hard disk or an internal memory of the computer device. The computer-readable storage medium may also be an external storage device of the computer device, such as a plug-in hard disk, a smart media card (SMC), a secure digital (SD) card or a flash card equipped on the computer device. Further, the computer-readable storage medium may also include both the internal storage unit and the external storage device of the computer device. The computer-readable storage medium is configured for storing the computer program and other programs and data required by the computer device. The computer-readable storage medium may also be configured for temporarily storing data that have been output or will be output.

According to an aspect, the present disclosure provides a computer program product, the computer program product including a computer program, the computer program being stored in a computer-readable storage medium. A processor of a computer device reads the computer program from the computer-readable storage medium and executes the computer program to cause the computer device to perform the method provided in one aspect of the embodiments of the present disclosure.

Terms such as “first” and “second” in the description, claims and accompanying drawings of the present disclosure are configured for distinguishing different objects, instead of describing a specific order. In addition, the terms “include” and any variant thereof are intended to cover a non-exclusive inclusion. For example, a process, method, apparatus, product, or device that includes a series of steps or units is not limited to the listed steps or units; and instead, in some embodiments, further includes a step or unit that is not listed, or in some embodiments, further includes another step or unit that is intrinsic to the process, method, apparatus, product, or device.

In the embodiments of the present disclosure, the term “module” or “unit” refers to a computer program having a predetermined function or a part of a computer program, and works together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

A person of ordinary skills in the art may understand that, units and algorithm steps of the examples described in the foregoing disclosed embodiments may be implemented by electronic hardware, computer software, or a combination thereof. To clearly describe the interchangeability between the hardware and the software, the foregoing has generally described compositions and steps of each example based on functions. Whether the functions are executed by means of hardware or software depends on particular applications and design constraint conditions of the technical solutions. A person skilled in the art may use different methods to implement the described functions for each particular application, but it is not considered that the implementation goes beyond the scope of the present disclosure.

The methods and related apparatuses according to the embodiments of the present disclosure are described with reference to the method flowcharts and/or schematic structural diagrams according to the embodiments of the present disclosure. Specifically, each process and/or block in the method flowcharts and/or schematic structural diagrams and the combination of process and/or block in the flowcharts and/or block diagrams can be implemented by computer program instructions. These computer program instructions can be provided to the processors of general-purpose computers, special-purpose computers, embedded processing units or other programmable data processing devices to generate a machine, so that the instructions executed by the processors of computers or other programmable data processing devices generate apparatuses for implementing the functions specified in one or more processes of the flowcharts and/or one or more blocks of the schematic structural diagrams. These computer program instructions may also be stored in a computer-readable memory that can guide a computer or other programmable data processing devices to work in a specific way, so that the instructions stored in the computer-readable memory generate a manufacturing product including an instruction apparatus, which implements the functions specified in one or more processes of the flowcharts and/or one or more blocks of the schematic structural diagrams. These computer program instructions may also be loaded onto a computer or other programmable data processing devices to enable a series of operation steps to be executed on the computer or other programmable devices to generate processing implemented by the computer, so that the instructions executed on the computer or other programmable devices provide steps for implementing the functions specified in one or more processes of the flowcharts and/or one or more blocks of the schematic structural diagrams.

What are disclosed above are merely exemplary embodiments of the present disclosure, and certainly are not intended to limit the scope of the claims of the present disclosure. Therefore, equivalent variations made in accordance with the claims of the present disclosure are still to fall within the scope of the present disclosure.

What is claimed is:

1. A data processing method, performed by a computer device and comprising:
acquiring a media object sequence to be played, the media object sequence being composed of a plurality of media objects;
determining an initial media encoding parameter corresponding to each media object based on a predicted network speed corresponding to the media object sequence;
selecting a target media object whose media quality does not satisfy a preset quality condition from the media object sequence based on a media quality of each media object at the corresponding initial media encoding parameter, satisfying the preset quality condition referring to a media quality being not higher than a quality upper limit threshold or not lower than a quality lower limit threshold;
analyzing the initial media encoding parameter of the target media object based on the predicted network speed to obtain an analysis result, the analysis result indicating whether the initial media encoding parameter of the target media object satisfies a parameter adjustment condition; and
adjusting the initial media encoding parameter of the target media object in response to the analysis result indicating that the initial media encoding parameter of the target media object satisfies the parameter adjustment condition, a media quality of the target media object at an adjusted media encoding parameter satisfying the preset quality condition.

2. The method according to claim 1, wherein the determining an initial media encoding parameter corresponding to each media object based on a predicted network speed corresponding to the media object sequence comprises:
acquiring an average network speed of a historical time period, and determining the average network speed as the predicted network speed of the media object sequence, the historical time period being earlier than a time when the media object sequence is played;
acquiring K configured media encoding parameters, parameter levels to which the K configured media encoding parameters belong being different from each other; and
performing parameter adaptation analysis on each media object based on the predicted network speed to select from the K configured media encoding parameters the initial media encoding parameter of each media object.

3. The method according to claim 1, wherein the acquiring an average network speed of a historical time period comprises:
sampling T time points from the historical time period according to a time sampling rule, T being a positive integer;
acquiring historical network speeds respectively corresponding to each of the T time points to obtain T historical network speeds;
determining an average value of the T historical network speeds; and
determining the average value of the T historical network speeds as the average network speed of the historical time period.

4. The method according to claim 1, wherein the performing parameter adaptation analysis on each media object based on the predicted network speed to select from the K configured media encoding parameters the initial media encoding parameter of each media object comprises:
determining a media object in the media object sequence as an analysis media object;
acquiring a media content of the analysis media object;
invoking a parameter prediction model based on the media content of the analysis media object, the parameter prediction model being deployed with the K configured media encoding parameters;
performing comprehensive analysis on the media content of the analysis media object and the predicted network speed through the parameter prediction model to output a predicted media encoding parameter adapted to the analysis media object, the predicted media encoding parameter being less than the predicted network speed; and
determining the predicted media encoding parameter of the analysis media object as the initial media encoding parameter of the analysis media object.

5. The method according to claim 1, wherein the target media object whose media quality does not satisfy the preset quality condition comprises a first media object with a lowest media quality in the media object sequence and a second media object with a highest media quality in the media object sequence; and the analysis result comprises a first analysis result of the first media object and a second analysis result of the second media object; and
the analyzing the initial media encoding parameter of the target media object based on the predicted network speed to obtain the analysis result comprises:
acquiring a first parameter analysis rule associated with the first media object and a second parameter analysis rule associated with the second media object, the first parameter analysis rule being configured to determine an up-adjustability attribute of a media encoding parameter of a media object based on the predicted network speed, and the second parameter analysis rule being configured to determine a down-adjustability attribute of a media encoding parameter of a media object;
determining the up-adjustability attribute of the initial media encoding parameter of the first media object by adopting the first parameter analysis rule and the predicted network speed;
determining the down-adjustability attribute of the initial media encoding parameter of the second media object by adopting the second parameter analysis rule;
determining that both the first analysis result and the second analysis result are condition-satisfied results in response to both the up-adjustability attribute of the initial media encoding parameter of the first media object and the down-adjustability attribute of the initial media encoding parameter of the second media object being adjustable attributes; and
determining that both the first analysis result and the second analysis result are condition-unsatisfied results in response to either the up-adjustability attribute of the initial media encoding parameter of the first media object or the down-adjustability attribute of the initial media encoding parameter of the second media object being a non-adjustable attribute.

6. The method according to claim 5, wherein the determining the up-adjustability attribute of the initial media encoding parameter of the first media object by adopting the first parameter analysis rule and the predicted network speed comprises:
determining the initial media encoding parameter of the first media object as a first initial encoding parameter, and determining a media quality of the first media object at the first initial encoding parameter as a first media quality;
comparing the first media quality with the quality lower limit threshold according to the first parameter analysis rule to obtain a first comparison result;
acquiring K configured media encoding parameters, parameter levels to which the K configured media encoding parameters belong being different from each other;
acquiring a configured media encoding parameter whose parameter level is higher than a parameter level of the first initial encoding parameter from the K configured media encoding parameters, and determining the configured media encoding parameter whose parameter level is higher than the parameter level of the first initial encoding parameter in the K configured media encoding parameters as an up-adjusted media encoding parameter; and
determining the up-adjustability attribute of the initial media encoding parameter of the first media object based on a difference between the predicted network speed and the up-adjusted media encoding parameter, and the first comparison result.

7. The method according to claim 6, wherein the determining the up-adjustability attribute of the initial media encoding parameter of the first media object based on a difference between the predicted network speed and the up-adjusted media encoding parameter, and the first comparison result comprises:
determining the up-adjustability attribute of the initial media encoding parameter of the first media object as an adjustable attribute in response to that the difference between the predicted network speed and the up-adjusted media encoding parameter is less than a difference threshold, and the first comparison result indicates that the first media quality is less than the quality lower limit threshold; and
determining the up-adjustability attribute of the initial media encoding parameter of the first media object as a non-adjustable attribute in response to that the difference between the predicted network speed and the up-adjusted media encoding parameter is greater than the difference threshold, or the first comparison result indicates that the first media quality is greater than the quality lower limit threshold.

8. The method according to claim 5, wherein the determining the down-adjustability attribute of the initial media encoding parameter of the second media object by adopting the second parameter analysis rule comprises:
determining the initial media encoding parameter of the second media object as a second initial encoding parameter, and determining a media quality of the second media object at the second initial encoding parameter as a second media quality;
comparing the second media quality with the quality upper limit threshold according to the second parameter analysis rule to obtain a second comparison result;
acquiring K configured media encoding parameters, parameter levels to which the K configured media encoding parameters belong being different from each other;
traversing the K configured media encoding parameters based on the second initial encoding parameter to obtain a traversal result;
determining the down-adjustability attribute of the initial media encoding parameter of the second media object as an adjustable attribute in response to that the second comparison result indicates that the second media quality is greater than the quality upper limit threshold, and the traversal result indicates that there is a configured media encoding parameter whose parameter level is lower than a parameter level of the second initial encoding parameter in the K configured media encoding parameters; and
determining the down-adjustability attribute of the initial media encoding parameter of the second media object as a non-adjustable attribute in response to that the second comparison result indicates that the second media quality is less than the quality upper limit threshold, or the traversal result indicates that there is no configured media encoding parameter whose parameter level is lower than the parameter level of the second initial encoding parameter in the K configured media encoding parameters.

9. The method according to claim 5, wherein the adjusting the initial media encoding parameter of the target media object comprises:
acquiring K configured media encoding parameters, parameter levels to which the K configured media encoding parameters belong being different from each other;
determining a configured media encoding parameter whose parameter level is higher than a parameter level of the first initial encoding parameter in the K configured media encoding parameters as an up-adjusted media encoding parameter, the first initial encoding parameter referring to the initial media encoding parameter of the first media object;
determining a configured media encoding parameter whose parameter level is lower than a parameter level of the second initial encoding parameter in the K configured media encoding parameters as a first down-adjusted media encoding parameter, the second initial encoding parameter referring to the initial media encoding parameter of the second media object; and
adjusting the initial media encoding parameter of the first media object to the up-adjusted media encoding parameter, and adjusting the initial media encoding parameter of the second media object to the first down-adjusted media encoding parameter.

10. The method according to claim 5, further comprising:
filtering out the first media object and the second media object from the media object sequence, and determining a media object sequence obtained after filtering as a filtered media object sequence;
selecting a media object with a highest media quality from the filtered media object sequence as an additional adjustment media object according to the media quality of each media object in the filtered media object sequence at the corresponding initial media encoding parameter;
acquiring a third parameter analysis rule associated with the additional adjustment media object, the third parameter analysis rule being configured for analyzing and detecting a down-adjustability attribute of a media encoding parameter of a media object;
determining the down-adjustability attribute of the initial media encoding parameter of the additional adjustment media object by adopting the third parameter analysis rule; and
determining a third analysis result of the additional adjustment media object as a condition-satisfied result in response to that the down-adjustability attribute of the initial media encoding parameter of the additional adjustment media object is an adjustable attribute, and adjusting the initial media encoding parameter of the additional adjustment media object.

11. The method according to claim 10, wherein the determining the down-adjustability attribute of the initial media encoding parameter of the additional adjustment media object by adopting the third parameter analysis rule comprises:
determining the initial media encoding parameter of the additional adjustment media object as a third initial encoding parameter, and determining a media quality of the additional adjustment media object at the third initial encoding parameter as a third media quality;
comparing the third media quality with the quality upper limit threshold according to the third parameter analysis rule to obtain a third comparison result;
acquiring a configured media encoding parameter whose parameter level is lower than a parameter level of the third initial encoding parameter from the K configured media encoding parameters, and determining the configured media encoding parameter whose parameter level is lower than the parameter level of the third initial encoding parameter in the K configured media encoding parameters as a second down-adjusted media encoding parameter; and
analyzing the down-adjustability attribute of the initial media encoding parameter of the additional adjustment media object based on the first down-adjusted media encoding parameter, the second down-adjusted media encoding parameter, and the up-adjusted media encoding parameter.

12. The method according to claim 11, wherein the analyzing the down-adjustability attribute of the initial media encoding parameter of the additional adjustment media object based on the first down-adjusted media encoding parameter, the second down-adjusted media encoding parameter, and the up-adjusted media encoding parameter comprises:
determining a first difference between the second initial encoding parameter and the first down-adjusted media encoding parameter, a second difference between the third initial encoding parameter and the second down-adjusted media encoding parameter, and a third difference between the up-adjusted media encoding parameter and the first initial encoding parameter;
determining a difference sum of the first difference and the second difference;
determining a difference between the difference sum and the third difference as a first fluctuation value;
determining a difference between the first difference and the third difference as a second fluctuation value;
determining the down-adjustability attribute of the initial media encoding parameter of the additional adjustment media object as a non-adjustable attribute in response to that the first fluctuation value is greater than the second fluctuation value; and
determining the down-adjustability attribute of the initial media encoding parameter of the additional adjustment media object as an adjustable attribute in response to that the first fluctuation value is less than the second fluctuation value.

13. A computer device, comprising a processor and a memory coupled to the processor,
the memory being configured to store a computer program, and the processor being configured to invoke the computer program to enable the computer device to perform:
acquiring a media object sequence to be played, the media object sequence being composed of a plurality of media objects;
determining an initial media encoding parameter corresponding to each media object based on a predicted network speed corresponding to the media object sequence;
selecting a target media object whose media quality does not satisfy a preset quality condition from the media object sequence based on a media quality of each media object at the corresponding initial media encoding parameter, satisfying the preset quality condition referring to a media quality being not higher than a quality upper limit threshold or not lower than a quality lower limit threshold;
analyzing the initial media encoding parameter of the target media object based on the predicted network speed to obtain an analysis result, the analysis result indicating whether the initial media encoding parameter of the target media object satisfies a parameter adjustment condition; and
adjusting the initial media encoding parameter of the target media object in response to the analysis result indicating that the initial media encoding parameter of the target media object satisfies the parameter adjustment condition, a media quality of the target media object at an adjusted media encoding parameter satisfying the preset quality condition.

14. The computer device according to claim 13, wherein the target media object whose media quality does not satisfy the preset quality condition comprises a first media object with a lowest media quality in the media object sequence and a second media object with a highest media quality in the media object sequence; and the analysis result comprises a first analysis result of the first media object and a second analysis result of the second media object; and
the analyzing the initial media encoding parameter of the target media object based on the predicted network speed to obtain an analysis result comprises:
determining an up-adjustability attribute of the initial media encoding parameter of the first media object based on the predicted network speed;
determining a down-adjustability attribute of the initial media encoding parameter of the second media object;
determining that both the first analysis result and the second analysis result are condition-satisfied results in response to both the up-adjustability attribute of the initial media encoding parameter of the first media object and the down-adjustability attribute of the initial media encoding parameter of the second media object being adjustable attributes; and
determining that both the first analysis result and the second analysis result are condition-unsatisfied results in response to either the up-adjustability attribute of the initial media encoding parameter of the first media object or the down-adjustability attribute of the initial media encoding parameter of the second media object being a non-adjustable attribute.

15. The computer device according to claim 14, wherein the analyzing the initial media encoding parameter of the target media object based on the predicted network speed to obtain the analysis result comprises:
acquiring a first parameter analysis rule associated with the first media object and a second parameter analysis rule associated with the second media object, the first parameter analysis rule being configured to determine an up-adjustability attribute of a media encoding parameter of a media object based on the predicted network speed, and the second parameter analysis rule being configured to determine a down-adjustability attribute of a media encoding parameter of a media object;
determining the up-adjustability attribute of the initial media encoding parameter of the first media object by adopting the first parameter analysis rule and the predicted network speed; and
determining the down-adjustability attribute of the initial media encoding parameter of the second media object by adopting the second parameter analysis rule.

16. The computer device according to claim 15, wherein the determining the up-adjustability attribute of the initial media encoding parameter of the first media object by adopting the first parameter analysis rule and the predicted network speed comprises:
determining the initial media encoding parameter of the first media object as a first initial encoding parameter, and determining a media quality of the first media object at the first initial encoding parameter as a first media quality;
comparing the first media quality with the quality lower limit threshold according to the first parameter analysis rule to obtain a first comparison result;
acquiring K configured media encoding parameters, parameter levels to which the K configured media encoding parameters belong being different from each other;
acquiring a configured media encoding parameter whose parameter level is higher than a parameter level of the first initial encoding parameter from the K configured media encoding parameters, and determining the configured media encoding parameter whose parameter level is higher than the parameter level of the first initial encoding parameter in the K configured media encoding parameters as an up-adjusted media encoding parameter; and
determining the up-adjustability attribute of the initial media encoding parameter of the first media object based on a difference between the predicted network speed and the up-adjusted media encoding parameter, and the first comparison result.

17. The computer device according to claim 16, wherein the determining the up-adjustability attribute of the initial media encoding parameter of the first media object based on a difference between the predicted network speed and the up-adjusted media encoding parameter, and the first comparison result comprises:
determining the up-adjustability attribute of the initial media encoding parameter of the first media object as an adjustable attribute in response to that the difference between the predicted network speed and the up-adjusted media encoding parameter is less than a difference threshold, and the first comparison result indicates that the first media quality is less than the quality lower limit threshold; and
determining the up-adjustability attribute of the initial media encoding parameter of the first media object as a non-adjustable attribute in response to that the difference between the predicted network speed and the up-adjusted media encoding parameter is greater than the difference threshold, or the first comparison result indicates that the first media quality is greater than the quality lower limit threshold.

18. The computer device according to claim 15, wherein the determining the down-adjustability attribute of the initial media encoding parameter of the second media object by adopting the second parameter analysis rule comprises:
determining the initial media encoding parameter of the second media object as a second initial encoding parameter, and determining a media quality of the second media object at the second initial encoding parameter as a second media quality;
comparing the second media quality with the quality upper limit threshold according to the second parameter analysis rule to obtain a second comparison result;
acquiring K configured media encoding parameters, parameter levels to which the K configured media encoding parameters belong being different from each other;
traversing the K configured media encoding parameters based on the second initial encoding parameter to obtain a traversal result;
determining the down-adjustability attribute of the initial media encoding parameter of the second media object as an adjustable attribute in response to that the second comparison result indicates that the second media quality is greater than the quality upper limit threshold, and the traversal result indicates that there is a configured media encoding parameter whose parameter level is lower than a parameter level of the second initial encoding parameter in the K configured media encoding parameters; and
determining the down-adjustability attribute of the initial media encoding parameter of the second media object as a non-adjustable attribute in response to that the second comparison result indicates that the second media quality is less than the quality upper limit threshold, or the traversal result indicates that there is no configured media encoding parameter whose parameter level is lower than the parameter level of the second initial encoding parameter in the K configured media encoding parameters.

19. The computer device according to claim 15, wherein the adjusting the initial media encoding parameter of the target media object comprises:
acquiring K configured media encoding parameters, parameter levels to which the K configured media encoding parameters belong being different from each other;
determining a configured media encoding parameter whose parameter level is higher than a parameter level of the first initial encoding parameter in the K configured media encoding parameters as an up-adjusted media encoding parameter, the first initial encoding parameter referring to the initial media encoding parameter of the first media object;
determining a configured media encoding parameter whose parameter level is lower than a parameter level of the second initial encoding parameter in the K configured media encoding parameters as a first down-adjusted media encoding parameter, the second initial encoding parameter referring to the initial media encoding parameter of the second media object; and
adjusting the initial media encoding parameter of the first media object to the up-adjusted media encoding parameter, and adjusting the initial media encoding parameter of the second media object to the first down-adjusted media encoding parameter.

20. A non-transitory computer-readable storage medium, having a computer program stored therein, the computer program being adapted to be loaded by a processor to perform:
acquiring a media object sequence to be played, the media object sequence being composed of a plurality of media objects;
determining an initial media encoding parameter corresponding to each media object based on a predicted network speed corresponding to the media object sequence;
selecting a target media object whose media quality does not satisfy a preset quality condition from the media object sequence based on a media quality of each media object at the corresponding initial media encoding parameter, satisfying the preset quality condition referring to a media quality being not higher than a quality upper limit threshold or not lower than a quality lower limit threshold;
analyzing the initial media encoding parameter of the target media object based on the predicted network speed to obtain an analysis result, the analysis result indicating whether the initial media encoding parameter of the target media object satisfies a parameter adjustment condition; and
adjusting the initial media encoding parameter of the target media object in response to the analysis result indicating that the initial media encoding parameter of the target media object satisfies the parameter adjustment condition, a media quality of the target media object at an adjusted media encoding parameter satisfying the preset quality condition.
